(19) United States
(12) Patent Application Publication
(10) Pub. No.: US 2023/0397187 A1
(43) Pub. Date: Dec. 7, 2023

(54) MULTIPLE WAVEFORMS FOR USE IN SIDELINK

(71) Applicant: QUALCOMM Incorporated, San Diego, CA (US)

(72) Inventors: Ahmed ELSHAFIE, San Diego, CA (US); Hung Dinh LY, San Diego, CA (US); Seyedkianoush HOSSEINI, San Diego, CA (US); Krishna Kiran MUKKAVILLI, San Diego, CA (US)

(21) Appl. No.: 17/804,975

(22) Filed: Jun. 1, 2022

(51) Int. Cl. H04W 72/12; H04W 72/02; H04W 24/10

(52) U.S. Cl. CPC H04W 72/1263; H04W 24/10; H04W 72/02

(57) ABSTRACT

Various aspects of the present disclosure generally relate to wireless communication. In some aspects, a first user equipment (UE) may obtain a sidelink resource pool configuration indicating multiple waveforms that are available for use for sidelink signals associated with a sidelink resource pool. The first UE may communicate, with a second UE and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE. Numerous other aspects are described.

### FIELD OF THE DISCLOSURE

Aspects of the present disclosure generally relate to wireless communication and to techniques and apparatuses for enabling multiple waveforms for use in sidelink.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a first user equipment (UE) for wireless communication. The first UE may include a memory and one or more processors coupled to the memory. The one or more processors may be configured to obtain a sidelink resource pool configuration indicating multiple waveforms that are available for use for sidelink signals associated with a sidelink resource pool. The one or more processors may be configured to communicate, with a second UE and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE.

Some aspects described herein relate to a wireless communication device for wireless communication. The wireless communication device may include a memory and one or more processors coupled to the memory. The one or more processors may be configured to transmit, to a first UE, a sidelink resource pool configuration indicating multiple waveforms that are available for use for sidelink signals associated with a sidelink resource pool. The one or more processors may be configured to transmit, to the first UE, an indication of a first waveform, from the multiple waveforms, that is to be used by the first UE for sidelink communications associated with the sidelink resource pool.

Some aspects described herein relate to a method of wireless communication performed by a first UE. The method may include obtaining a sidelink resource pool configuration indicating multiple waveforms that are available for use for sidelink signals associated with a sidelink resource pool. The method may include communicating, with a second UE and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE.

Some aspects described herein relate to a method of wireless communication performed by a wireless communication device. The method may include transmitting, to a first UE, a sidelink resource pool configuration indicating multiple waveforms that are available for use for sidelink signals associated with a sidelink resource pool. The method may include transmitting, to the first UE, an indication of a first waveform, from the multiple waveforms, that is to be used by the first UE for sidelink communications associated with the sidelink resource pool.

Some aspects described herein relate to a non-transitory computer-readable medium that stores a set of instructions for wireless communication by a first UE. The set of instructions, when executed by one or more processors of the first UE, may cause the first UE to obtain a sidelink resource pool configuration indicating multiple waveforms that are available for use for sidelink signals associated with a sidelink resource pool. The set of instructions, when executed by one or more processors of the first UE, may cause the first UE to communicate, with a second UE and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE.

Some aspects described herein relate to a non-transitory computer-readable medium that stores a set of instructions for wireless communication by a wireless communication device. The set of instructions, when executed by one or more processors of the wireless communication device, may cause the wireless communication device to transmit, to a first UE, a sidelink resource pool configuration indicating multiple waveforms that are available for use for sidelink signals associated with a sidelink resource pool. The set of instructions, when executed by one or more processors of the wireless communication device, may cause the wireless communication device to transmit, to the first UE, an indication of a first waveform, from the multiple waveforms, that is to be used by the first UE for sidelink communications associated with the sidelink resource pool.

Some aspects described herein relate to an apparatus for wireless communication. The apparatus may include means for obtaining a sidelink resource pool configuration indicating multiple waveforms that are available for use for sidelink signals associated with a sidelink resource pool. The apparatus may include means for communicating, with a second apparatus and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE.

Some aspects described herein relate to an apparatus for wireless communication. The apparatus may include means for transmitting, to a first UE, a sidelink resource pool configuration indicating multiple waveforms that are available for use for sidelink signals associated with a sidelink resource pool. The apparatus may include means for transmitting, to the first UE, an indication of a first waveform, from the multiple waveforms, that is to be used by the first UE for sidelink communications associated with the sidelink resource pool.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a sidelink configuration, in accordance with the present disclosure.

FIG. 6 is a diagram of an example associated with multiple waveforms for use in sidelink, in accordance with the present disclosure.

FIG. 7 is a diagram illustrating an example process performed, for example, by a first UE, in accordance with the present disclosure.

FIG. 8 is a diagram illustrating an example process performed, for example, by a wireless communication device, in accordance with the present disclosure.

FIG. 9 is a diagram of an example apparatus for wireless communication.

FIG. 10 is a diagram of an example apparatus for wireless communication.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

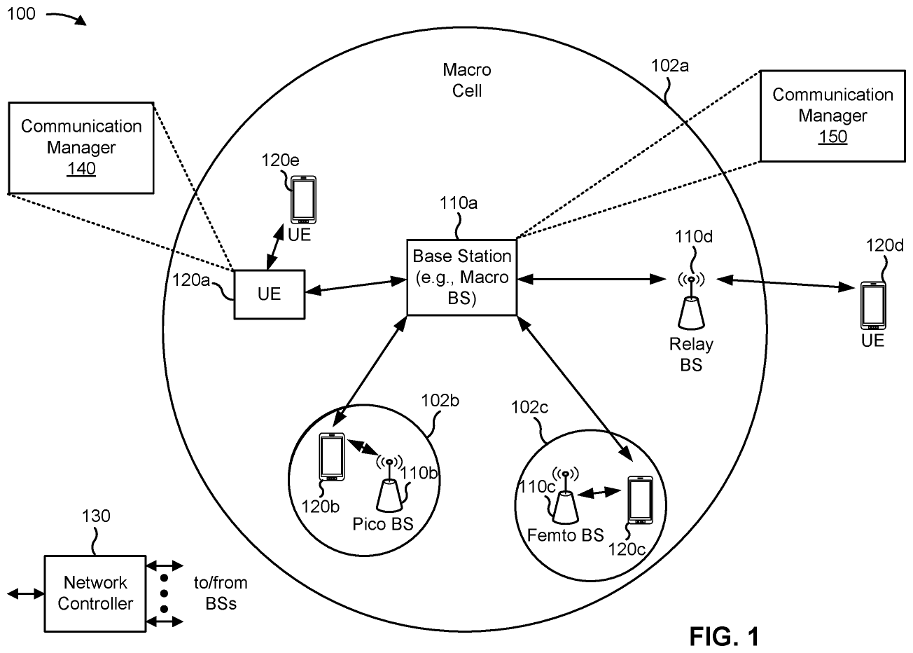

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (for example, the base station 110) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (MC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE 120 may include a communication manager 140. As described in more detail elsewhere herein, the communication manager 140 may obtain a sidelink resource pool configuration indicating multiple waveforms that are available for use for sidelink signals associated with a sidelink resource pool; and communicate, with a second UE and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE. Additionally, or alternatively, the communication manager 140 may perform one or more other operations described herein.

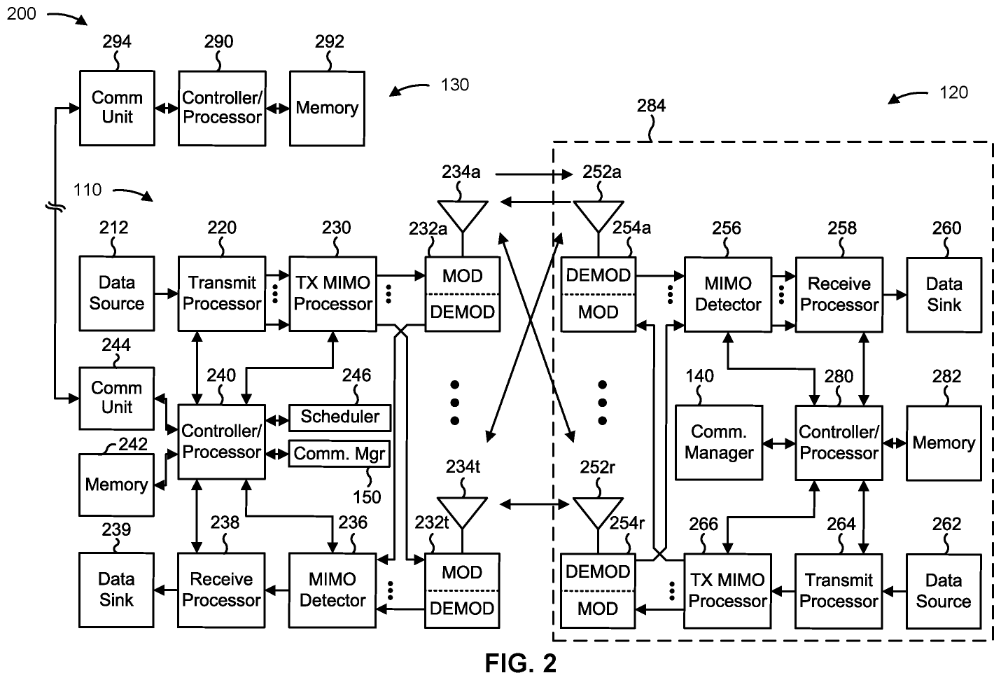

In some aspects, a network entity (e.g., shown as the base station 110 in FIGS. 1 and 2 as an example) may include a communication manager 150. As described in more detail elsewhere herein, the communication manager 150 may transmit, to a first UE, a sidelink resource pool configuration indicating multiple waveforms that are available for use for sidelink signals associated with a sidelink resource pool; and transmit, to the first UE, an indication of a first waveform, from the multiple waveforms, that is to be used by the first UE for sidelink communications associated with the sidelink resource pool. Additionally, or alternatively, the communication manager 150 may perform one or more other operations described herein.

As indicated above, FIG. 1 is provided as an example. Other examples may differ from what is described with regard to FIG. 1.

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

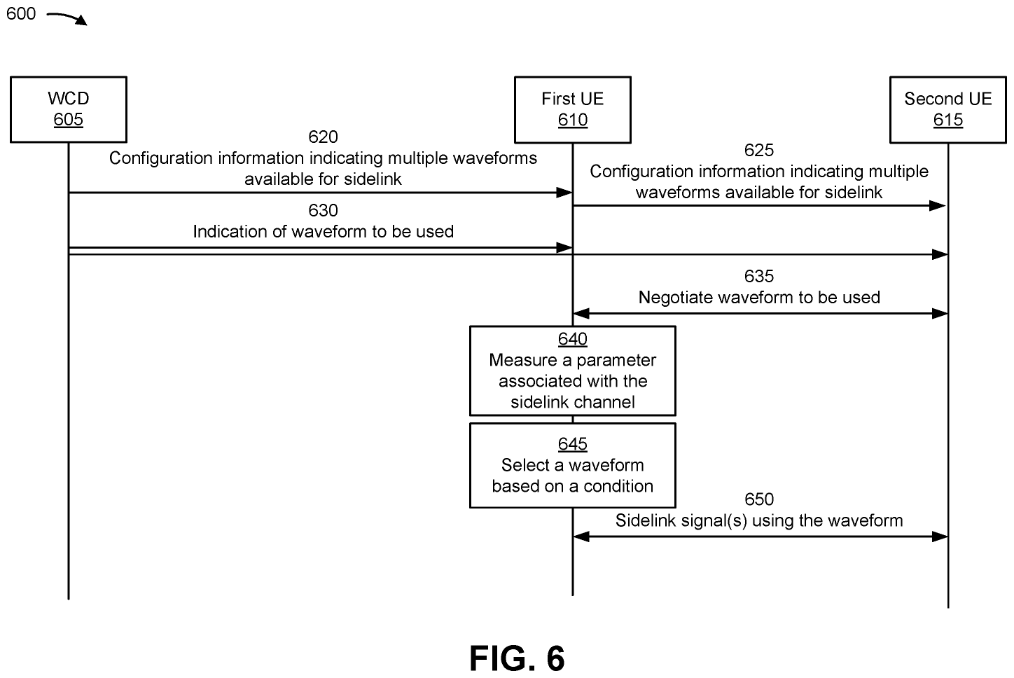

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

The controller/processor 240 of the base station 110, the controller/processor 280 of the UE 120, and/or any other component(s) of FIG. 2 may perform one or more techniques associated with enabling multiple waveforms for use in sidelink, as described in more detail elsewhere herein. In some aspects, the wireless communication device described herein is the UE 120, is included in the UE 120, or includes one or more components of the UE 120 shown in FIG. 2. In some other aspects, the wireless communication device described herein is a network entity (shown in FIG. 2 as a base station 110 as an example), is included in a network entity, or includes one or more components of the network entity shown in FIG. 2.

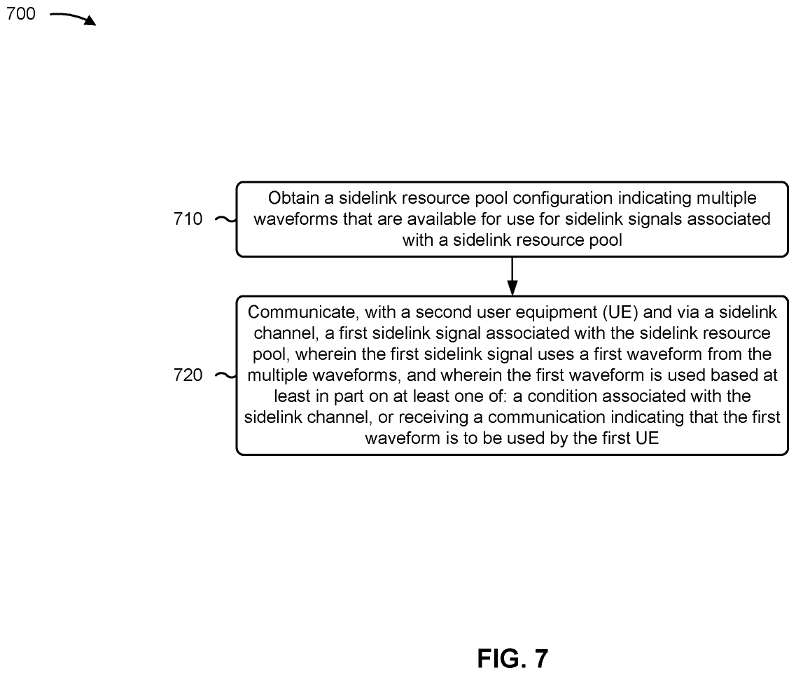

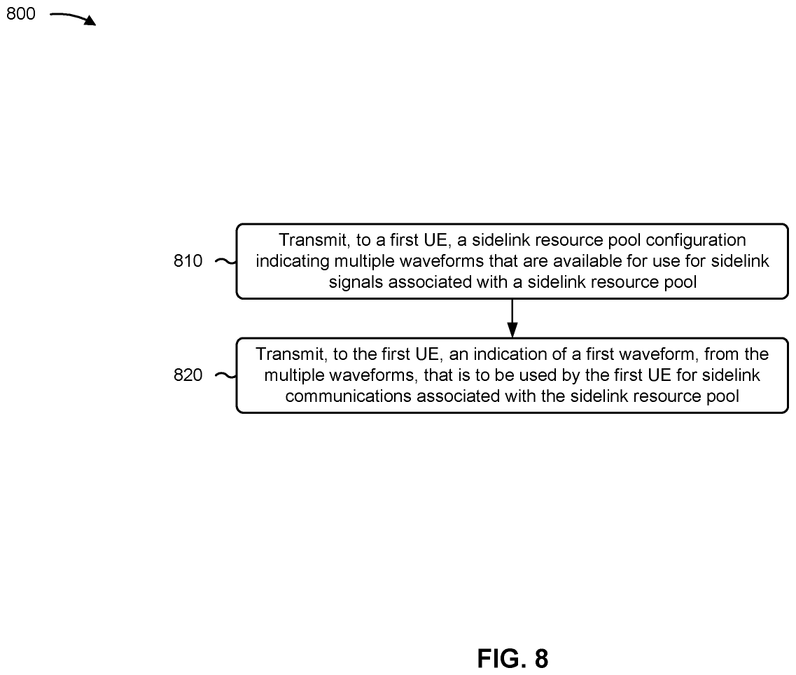

For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a first UE includes means for obtaining a sidelink resource pool configuration indicating multiple waveforms that are available for use for sidelink signals associated with a sidelink resource pool; and/or means for communicating, with a second UE and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a wireless communication device includes means for transmitting, to a first UE, a sidelink resource pool configuration indicating multiple waveforms that are available for use for sidelink signals associated with a sidelink resource pool; and/or means for transmitting, to the first UE, an indication of a first waveform, from the multiple waveforms, that is to be used by the first UE for sidelink communications associated with the sidelink resource pool. In some aspects, the means for the wireless communication device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some other aspects, the means for the wireless communication device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G New Radio (NR) systems, may be arranged in multiple manners with various components or constituent parts. In a NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

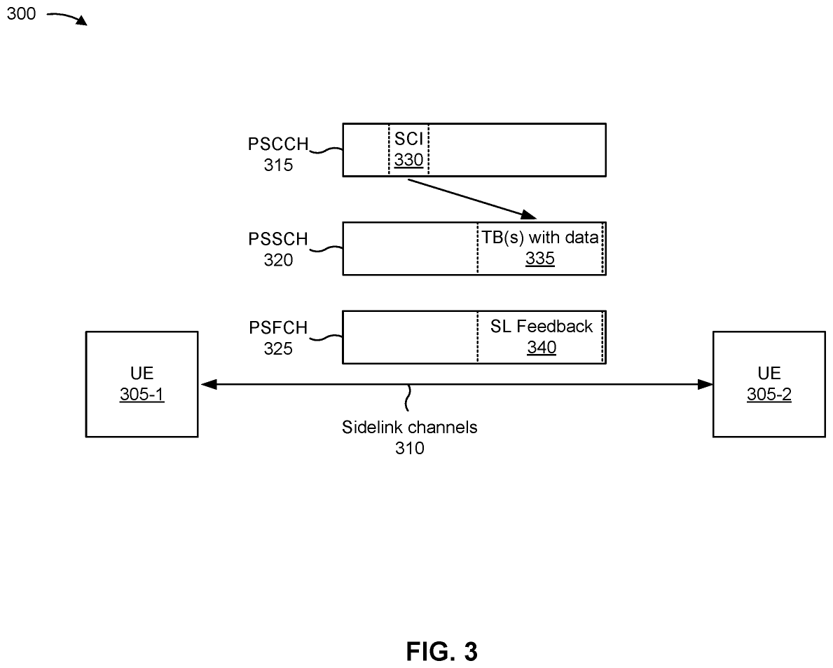

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some examples, the UEs 305 (e.g., UE 305-1 and/or UE 305-2) may correspond to one or more other UEs described elsewhere herein, such as UE 120. In some examples, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some examples, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

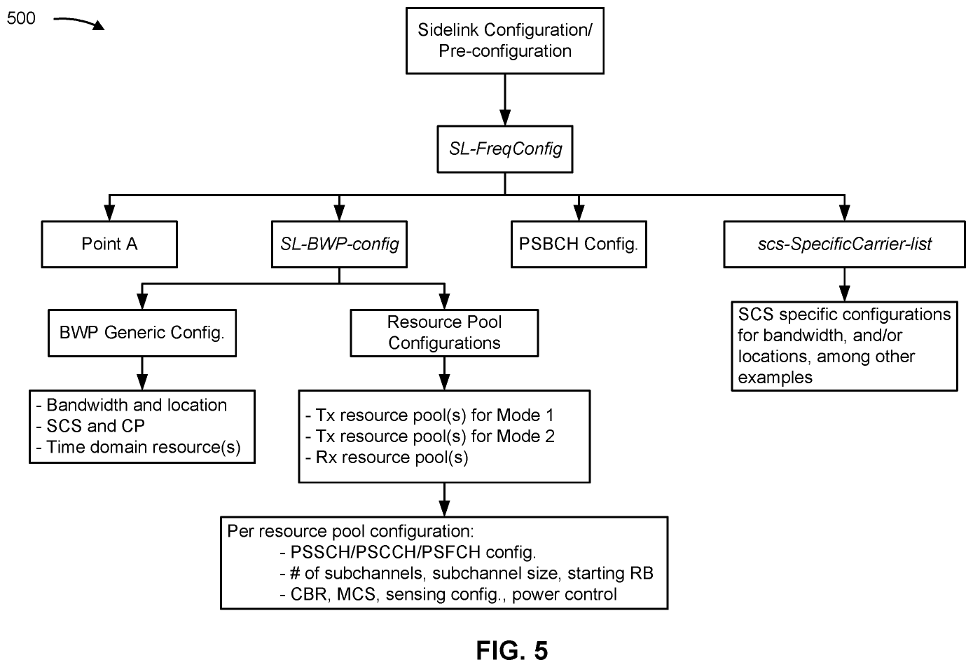

In some examples, the one or more sidelink channels 310 may use resource pools. For example, a scheduling assignment (e.g., included in SCI 330) may be transmitted in sub-channels using specific resource blocks (RBs) across time. In some examples, data transmissions (e.g., on the PSSCH 320) associated with a scheduling assignment may occupy adjacent RBs in the same subframe as the scheduling assignment (e.g., using frequency division multiplexing). In some examples, a scheduling assignment and associated data transmissions are not transmitted on adjacent RBs. Example configurations for sidelink resource pools are described in more detail in connection with FIG. 5.

In some examples, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some examples, a UE 305 may operate using a transmission mode (e.g., Mode 2) where resource selection and/or scheduling is performed by the UE 305 (e.g., rather than a base station 110). In some examples, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure an RSRP parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some examples, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

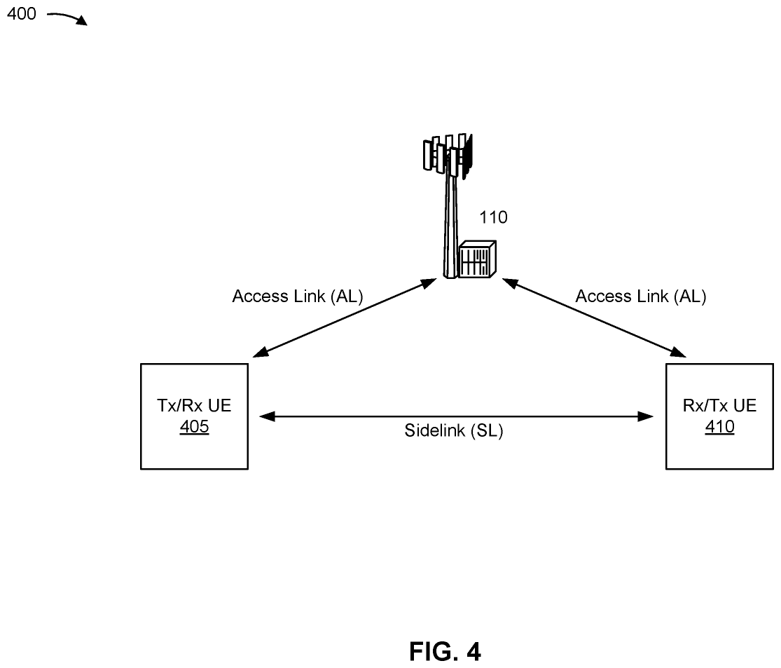

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

FIG. 5 is a diagram illustrating an example 500 of a sidelink configuration, in accordance with the present disclosure. A UE, such as a UE 120, the UE 305-1, the UE 305-2, the Tx/Rx UE 405, and/or the Rx/Tx UE 410, may obtain a sidelink configuration indicating information and/or parameters associated with communicating via a sidelink channel. For example, the UE may receive the sidelink configuration from a network entity (e.g., via an RRC configuration). As another example, the UE may receive the sidelink configuration from another UE (e.g., via a sidelink RRC configuration). In some cases, the sidelink configuration (or a portion of the sidelink configuration) may be stored in a memory of the UE prior to the UE communicating with a network entity or another UE (e.g., the UE may be pre-configured with the sidelink configuration or a portion of the sidelink configuration, such as in an original equipment manufacturer (OEM) configuration). Therefore, as used herein, a UE “obtaining” configuration information may refer to the UE receiving a signal that indicates the configuration information and/or the UE retrieving the configuration information from a memory of the UE.

Some sidelink configuration parameters or configuration fields described herein may be defined, or otherwise fixed, by a wireless communication standard, such as the 3GPP (e.g., such as in 3GPP Technical Specification (T.S.) 38.331 Version 16.7.0). As shown in FIG. 5, the sidelink configuration may include a sidelink frequency configuration (SL-FreqConfig). The SL-FreqConfig may indicate dedicated configuration information on one particular carrier frequency for sidelink communication. For example, the SL-FreqConfig may include a field (e.g., sl-AbsoluteFrequencyPointA) indicating a frequency reference point of a reference resource block (e.g., common RB 0). The field (e.g., sl-AbsoluteFrequencyPointA) may indicate a lowest subcarrier associated with the sidelink channel, which may be referred to as “Point A.” Additionally, or alternatively, the SL-FreqConfig may indicate additional configuration information, such as a frequency location of a sidelink synchronization signal block (SSB) (e.g., via an sl-AbsoluteFrequencySSB field), a list of sidelink bandwidth parts (BWPs) on which the sidelink communication configuration is to be added or reconfigured (e.g., via an sl-BWP-ToAddModList field), a list of sidelink BWPs on which the sidelink communication configuration is to be released (e.g., via an sl-BWP-ToReleaseList field), an identifier of the dedicated configuration information on the carrier frequency for sidelink communication (e.g., via an sl-Freq-Id field), and/or one or more UE specific channel bandwidth and location configurations for different subcarrier spacings (SCSs) (e.g., numerologies) that are defined in relation to Point A (e.g., via an sl-SCS-SpecificCarrierList field), among other examples.

As shown in FIG. 5, the sidelink configuration may include a physical sidelink broadcast channel (PSBCH) configuration (e.g., an SL-PSBCH-Config). The SL-PSBCH-Config may indicate PSBCH transmission parameters for one or more (or for each) configured sidelink BWP. For example, the SL-PSBCH-Config may indicate an alpha value for downlink pathloss (PL)-based power control for the PSBCH (e.g., via a dl-Alpha-PSBCH field) and/or a PO value for downlink pathloss based power control for the PSBCH (e.g., via a dl-PO-PSBCH field), among other examples.

The sidelink configuration may include a sidelink BWP configuration (e.g., an SL-BWP-Config). The SL-BWP-Config may indicate UE specific configuration information for sidelink communication on one particular sidelink BWP. For example, the SL-BWP-Config may include a generic BWP configuration (e.g., in an sl-BWP-Generic field). The generic BWP configuration may indicate one or more generic parameters on the configured sidelink BWP, such as a bandwidth size of the BWP, a frequency location (e.g., relative to the Point A) of the BWP, a numerology (e.g., an SCS and/or cyclic prefix (CP), among other examples) of the BWP, time domain resource(s) associated with the BWP, a quantity of symbols used for sidelink in a slot without a sidelink SSB, a starting symbol used for sidelink in a slot without a sidelink SSB, and/or a subcarrier index within the carrier corresponding to the numerology of the corresponding sidelink BWP indicating a sidelink Tx/Rx Direct Current location for the carrier, among other examples.

The SL-BWP-Config may indicate resource pool configurations associated with one particular sidelink BWP (e.g., via an sl-BWP-PoolConfig information element (IE) and/or an SL-ResourcePool IE). For example, the resource pool configurations may include one or more resource pool configurations associated with sidelink transmissions for the operating Mode 1, one or more resource pool configurations associated with sidelink transmissions for the operating Mode 2, and/or resource pool configurations associated with sidelink receptions, among other examples.

For example, an SL-ResourcePool IE may indicate configuration information for a given sidelink communication resource pool. The SL-ResourcePool IE may indicate one or more sidelink physical channel configurations for the resource pool (e.g., an SL-PSCCH-Config, an SL-PSSCH-Config, and/or an SL-PSFCH-Config, among other examples). Additionally, or alternatively, the SL-ResourcePool IE may indicate a quantity of subchannels associated with the resource pool (e.g., via an sl-NumSubchannel field), a subchannel size (e.g., in terms of a quantity of physical RBs (PRBs)) of the subchannels associated with the resource pool (e.g., via an sl-SubchannelSize field), and/or a starting RB associated with the resource pool (e.g., via an sl-StartRB-Subchannel field), among other examples. Additionally, or alternatively, the SL-ResourcePool IE may indicate a time window size for CBR measurement associated with the resource pool (e.g., via an sl-TimeWindowSize CBR field), one or more MCSs associated with the resource pool (e.g., via an SL-MinMaxMCS-Config IE and/or an sl-MCS-Table field), a sensing configuration associated with the resource pool (e.g., via an sl-RS-ForSensing field, and/or an sl-SensingWindow field, among other examples), and/or a power control configuration associated with the resource pool (e.g., via an SL-PowerControl IE), among other examples. The SL-ResourcePool IE may indicate additional configuration information, configuration parameters, and/or configuration fields, such as defined, or otherwise fixed, by 3GPP T.S. 38.331 Version 16.7.0.

As described above, a given BWP may be configured with multiple transmitting resource pools (e.g., for transmitting sidelink communications) and/or multiple receiving resource pools (e.g., for receiving sidelink communications). Physical sidelink channels may be configured per resource pool (e.g., each resource pool may have separate physical sidelink channel configurations).

As indicated above, FIG. 5 is provided as an example. Other examples may differ from what is described with respect to FIG. 5.

In some cases, it may be desirable for a UE or other wireless communication device to use higher operating bands (e.g., 100 GHz operating bands or other operating bands) for performing communications. For example, higher operating bands may enable communication of a larger amount of data. However, communicating using the higher operating bands may result in an increased phase noise (PN) of the communication, a lower peak-to-average-power ratio (PAPR) of the communication, and/or an increase in UE complexity requirements. In some cases, certain waveforms may be used to improve these conditions.

In some cases, a CP-OFDM waveform may be used for performing a communication. In this example, a modulation symbol (e.g., a quadrature amplitude modulation (QAM) symbol) may be mapped to the time domain using an inverse fast Fourier transform (iFFT), and a cyclic prefix may be added to the time domain symbol. The symbol may be transmitted in the time domain with the cyclic prefix. Some characteristics of the CP-OFDM waveform may include higher UE complexity, single tap frequency domain equalization (FDE), efficient bandwidth utilization, simple frequency division multiplexing (FDM), increased subcarrier spacing (SCS), and enablement of higher order MIMO communications.

In some cases, a single carrier (SC) frequency domain waveform (e.g., a DFT-s-OFDM waveform) may be used for performing a communication. In such examples, time domain modulation symbols may be mapped to the frequency domain using a DFT operation. The output of the DFT operation may be mapped to one or more tones. The one or more tones may be mapped to the time domain using an iFFT operation. The DFT-s-OFDM waveform may allow for an oversampling of the communication. The DFT-s-OFDM waveform may use a guard interval or a cyclic prefix. Some characteristics of the DFT-s-OFDM waveform include higher UE complexity, single tap FDE, efficient bandwidth utilization, FDM with PAPR impact, and increased SCS.

In some cases, an SC time domain implementation waveform (e.g., an SC-FDE waveform or SC-QAM waveform) may be used for performing a communication. In such examples, the tones (e.g., resource elements) may be oversampled without the use of the DFT and the iFFT operations. The SC-FDE and/or SC-QAM waveform may use a guard interval or a cyclic prefix. Some characteristics of the SC-FDE and/or SC-QAM waveform may include lower UE complexity, single tap FDE or time domain equalization (TDE), FDM with guard bands, low signal to noise ratio (SNR), and low PAPR (e.g., as a result of time domain filtering).

As described above, these waveforms are provided for the purposes of example only. The waveforms described herein are not limited to the examples above. Additional, or alternative, waveforms may be used in a similar manner as described herein (e.g., for reducing phase noise, enabling higher PAPR, or reducing UE complexity, among other examples).

Typically, as described in more detail elsewhere herein, a sidelink channel or BWP may be associated with a single waveform. For example, UEs may communicate via a sidelink using a DFT-s-OFDM waveform. In some examples, the waveform for the sidelink channel may be stored by a UE (e.g., and not indicated in a sidelink configuration). As described above, in some cases, it may be beneficial for multiple waveforms to be available for use via a sidelink channel. However, sidelink scenarios introduce additional complexities as to how to configure multiple waveforms to be available for use on a sidelink channel and/or when to use a given waveform from the multiple waveforms available for use, among other examples. For example, in some sidelink scenarios, a UE communication via a sidelink channel may not have an established connection with a network entity, such as when the UE is operating in the sidelink Mode 2. Therefore, in some cases, a network entity may be unable to configure and/or synchronize a waveform to be used to communicate on the sidelink channel for all UEs communicating using the sidelink channel. Additionally, UEs may communicate via a sidelink channel prior to establishing a connection (e.g., an RRC connection over a Uu interface) with a network entity. As a result, in some cases, a UE may be unclear as to what waveforms are available to be used for the sidelink channel, how to select a given waveform (e.g., from multiple available waveforms) for a given sidelink communication, and/or how to ensure that other UEs communicating via the sidelink channel are using the same waveform that is selected by the UE, among other examples.

Some techniques and apparatuses described herein enable multiple waveforms for use in a sidelink channel. For example, a UE may obtain a sidelink resource pool configuration indicating multiple waveforms that are available for use for sidelink signals associated with a sidelink resource pool. The UE may communicate (e.g., transmit and/or receive) a sidelink signal associated with the sidelink resource pool via a sidelink channel. The UE may use a first waveform, from the multiple waveforms, to communicate the sidelink signal. The first waveform may be used by the UE based at least in part on a condition associated with the sidelink channel. Additionally, or alternatively, the first waveform may be used by the UE based at least in part on the UE receiving a communication indicating that the first waveform is to be used by the UE.

As a result, the UE may be configured with multiple waveforms that are available to be used for the communication of sidelink signals associated with a sidelink resource pool. Additionally, the UE may be enabled to select and/or identify a waveform, from the multiple waveforms, to be used for given sidelink communication. Enabling the use of multiple waveforms may improve sidelink communication performance by enabling the UE to flexibly use different waveforms at different times and/or when experiencing different conditions associated with the sidelink channel. For example, at a first time, the UE may transmit and/or receive sidelink communications using a first waveform to reduce a PAPR. At a second time, the UE may transmit and/or receive sidelink communications using a second waveform for increased SCS and/or enablement of higher order MIMO communications, among other examples. Additionally, some techniques and apparatuses described herein provide mechanisms to enable UEs communicating on the sidelink channel to synchronize which waveform, from multiple waveforms, is to be used at a given time and/or for a given sidelink communication (e.g., such as in scenarios where one or more of the UEs are not connected to a network entity).

FIG. 6 is a diagram of an example 600 associated with multiple waveforms for use in sidelink, in accordance with the present disclosure. As shown in FIG. 6, a first UE 610 (e.g., a UE 120) may communicate with a wireless communication device (WCD) 605 and a second UE 615. The WCD 605 may include a network entity (e.g., a base station 110, a CU, a DU, and/or an RU), a core network node, a UE (e.g., a UE 120), and/or another WCD (e.g., a roadside unit), among other examples. In some aspects, the WCD 605, the first UE 610, and the second UE 615 may be part of a wireless network (e.g., the wireless network 100). In some aspects, the first UE 610 and the WCD 605 may have established a wireless connection prior to operations shown in FIG. 6 (e.g., via a Uu interface or a PC5 interface). In some aspects, the first UE 610 and the second UE 615 may have established a wireless connection prior to operations shown in FIG. 6 (e.g., via a sidelink channel or a PC5 interface, in a similar manner as described in connection with FIGS. 3 and 4). As described in more detail elsewhere herein, the first UE 610 and the second UE 615 may communicate via a sidelink channel where multiple waveforms are available to be used. The multiple waveforms may include a CP-OFDM based waveform, an SC based waveform, a DFT-s-OFDM based waveform, and/or an SC-QAM based waveform, among other examples.

In some aspects, the first UE 610 may obtain a sidelink resource pool configuration indicating the multiple waveforms that are available for use for sidelink signals associated with a sidelink resource pool. In some aspects, some (or all) information indicated by the sidelink resource pool configuration may be stored by the first UE 610. Additionally, or alternatively, some (or all) information indicated by the sidelink resource pool configuration may be received by the first UE 610 (e.g., received as shown by reference number 620). For example, as used herein, “obtaining” the sidelink resource pool configuration may include accessing or retrieving information from a memory and/or receiving information associated with the sidelink resource pool configuration (e.g., via an over-the-air signal), such as shown by reference number 620.

In some aspects, the first UE 610 may transmit an indication that the first UE 610 supports using multiple waveforms for sidelink communications. For example, the first UE 610 may transmit the indication to the WCD 605, the second UE 615, and/or another device. The indication may be included in a capability communication (e.g., a UE capability report). For example, the first UE 610 may transmit the indication that the first UE 610 supports using multiple waveforms for sidelink communications in an uplink control channel communication, a sidelink control channel communication, a UE assistance information (UAI) communication, and/or another type of communication. In some aspects, the first UE 610 may transmit an indication of one or more waveforms that are supported by the first UE 610 for sidelink communications (e.g., the first UE 610 may report a list of waveforms that are supported by the first UE 610 for sidelink communications).

In some aspects, the first UE 610 may be configured with multiple waveforms (or a waveform from multiple waveforms) to be used for a particular sidelink resource pool (e.g., as described in more detail elsewhere herein) based at least in part on transmitting the indication that the first UE 610 supports using multiple waveforms for sidelink communications. For example, if the first UE 610 indicates that the first UE 610 supports using multiple waveforms for sidelink communications, then the WCD 605 (or another device) may determine that the first UE 610 can be configured with multiple waveforms for one or more sidelink resource pool. Alternatively, if the first UE 610 indicates that the first UE 610 does not support using multiple waveforms for sidelink communications, then the WCD 605 (or another device) may determine that the first UE 610 cannot be configured with multiple waveforms for one or more sidelink resource pools. The second UE 615 may transmit an indication that the second UE 615 supports using multiple waveforms for sidelink communications in a similar manner as described above.

In some aspects and as shown by reference number 620, the WCD 605 may transmit, and the first UE 610 may receive, a sidelink resource pool configuration indicating the multiple waveforms that are available for use for sidelink signals associated with a sidelink resource pool. In some aspects, the first UE 610 may receive the sidelink resource pool configuration via one or more of RRC signaling, one or more medium access control (MAC) control elements (MAC-CEs), and/or DCI, among other examples. In some aspects, the sidelink resource pool configuration may include an indication of one or more configuration parameters (e.g., stored by the first UE 610) for selection by the first UE 610, and/or explicit configuration information for the first UE 610 to use to configure itself, among other examples. In some aspects, the first UE 610 may receive the sidelink resource pool configuration from a network entity. For example, when the WCD 605 is a network entity, the first UE 610 may receive the sidelink resource pool configuration via a Uu interface. For example, the first UE 610 may receive the sidelink resource pool configuration via a Uu interface RRC communication, a Uu interface MAC-CE communication, and/or a Uu interface control information communication (e.g., a DCI communication), among other examples.

In some other aspects, the first UE 610 may receive the sidelink resource pool configuration from the second UE 615 or another UE. For example, when the WCD 605 is a UE, the first UE 610 may receive the sidelink resource pool configuration via a PC5 interface. For example, the first UE 610 may receive the sidelink resource pool configuration via a PC5 interface RRC communication, a PC5 interface MAC-CE communication, and/or a PC5 interface control information communication (e.g., an SCI communication), among other examples. In such examples, the WCD 605 (e.g., a UE in this example) may receive the sidelink resource pool configuration from a network entity (e.g., via a Uu interface). The WCD 605 (e.g., a UE in this example) may forward the sidelink resource pool configuration received from the network entity to the first UE 610. In such examples, the first UE 610 may be outside of a coverage area of the network entity (e.g., outside of an area associated with a cell of the network entity). Therefore, the WCD 605 may forward the sidelink resource pool configuration to the first UE 610.

The sidelink resource pool configuration may be included in a sidelink BWP configuration (e.g., an SL-BWP-Config). The sidelink BWP configuration may be similar to the SL-BWP-Config described above in connection with FIG. 5. For example, an indication of the multiple waveforms may be included in a field or configuration parameter associated with an sl-BWP-PoolConfig IE and/or an SL-ResourcePool IE, among other examples. For example, in a sidelink channel, each configured resource pool may be associated with respective CBR values which may be used for rate control (e.g., by indicating a maximum number of resource blocks that a UE can use for a particular set of subframes). In some aspects, the CBR may indicate a maximum transmit power that a UE can use when transmitting sidelink communications via the resource pool. Because a performance of waveforms may be associated with, or correlated with, a transmission power used by a UE, the multiple waveforms may be configured on a per-resource-pool basis (e.g., because the maximum transmit power for a UE may be different in different resource pools).

In some aspects, the sidelink resource pool configuration may indicate a single waveform (e.g., from multiple waveforms available to be used on a sidelink channel) that is to be associated with the resource pool. For example, a field or configuration parameter associated with an sl-BWP-PoolConfig IE and/or an SL-ResourcePool IE, among other examples, may indicate the waveform to be associated with the resource pool. In some other aspects, the sidelink resource pool configuration may indicate multiple waveforms that are to be associated with the resource pool. The first UE 610 may use a waveform, from the multiple waveforms, for sidelink communications associated with the resource pool based at least in part on a condition associated with the sidelink channel and/or on receiving a communication indicating that the waveform is to be used by the first UE 610, among other examples (e.g., as described in more detail elsewhere herein).

In some aspects, as shown by reference number 625, the first UE 610 may transmit, and the second UE 615 may receive, an indication of the sidelink resource pool configuration indicating the multiple waveforms that are available for use for sidelink signals associated with a sidelink resource pool. For example, the first UE 610 may forward the sidelink resource pool configuration (e.g., received from the WCD 605) to the second UE 615. The first UE 610 may transmit the sidelink resource pool configuration via a PC5 interface RRC communication, a PC5 interface MAC-CE communication, and/or a PC5 interface control information communication (e.g., a SCI communication), among other examples. In some aspects, the first UE 610 may transmit, and the second UE 615 may receive, an indication of the sidelink resource pool configuration as part of a sidelink RRC connection establishment procedure.

In some aspects, the first UE 610 may transmit one or more sidelink communications prior to obtaining the sidelink resource pool configuration. In such examples, the first UE 610 may communicate (e.g., transmit and/or receive), with the second UE 615 or another UE and prior to obtaining the sidelink resource pool configuration, a sidelink signal using a default waveform. As used herein, “default waveform” may refer to a waveform that is to be used on a sidelink channel prior to receiving a sidelink resource pool configuration and/or to be used for certain types of communications (e.g., initial access communications, SSBs, sidelink SSBs, or other types of communications), among other examples. In some aspects, the default waveform may be defined, or otherwise fixed, by a wireless communication standard, such as the 3GPP. For example, an indication of the default waveform may be stored by the first UE 610 (e.g., as part of an original equipment manufacturer (OEM) configuration). For example, the first UE 610 may be preconfigured (e.g., loaded in a memory) with certain (e.g., default) waveforms to use during initial communications or before other waveforms have been configured for the sidelink channel. In some aspects, the first UE 610 may receive an indication of one or more default waveforms to be used by the first UE 610.

In some aspects, the default waveform may be based at least in part on a frequency band used to communicate a sidelink signal. For example, if the first UE 610 uses a first frequency band to transmit and/or receive a sidelink communication, then the first UE 610 may use a first default waveform. If the first UE 610 uses a second frequency band to transmit and/or receive a sidelink communication, then the first UE 610 may use a second default waveform. In other words, the one or more default waveforms may include a first default waveform associated with a first frequency band, a second default waveform associated with a second frequency band, and so on. As an example, a CP-OFDM based waveform may be a default waveform for a lower frequency band (e.g., a frequency band associated with an operating frequency less than or equal to 60 GHz) and an SC based waveform (e.g., a DFT-s-OFDM based waveform and/or an SC-QAM based waveform) may be a default waveform for a higher frequency band (e.g., a frequency band associated with an operating frequency greater than 60 GHz).

In some aspects, a default waveform may be used by the first UE 610 and/or the second UE 615 to transmit or receive certain types of sidelink signals. For example, the first UE 610 and/or the second UE 615 may transmit and/or receive sidelink SSBs using a default waveform. Similar to the default waveforms described above, different frequency bands may be associated with different default waveforms for communicating sidelink SSBs. For example, SSBs may be transmitted by the first UE 610 and/or the second UE 615 using a default waveform that is based at least in part on a band of operation. As an example, a CP-OFDM based waveform may be a default waveform for sidelink SSBs for a lower frequency band (e.g., a frequency band associated with an operating frequency less than or equal to 60 GHz) and an SC based waveform (e.g., a DFT-s-OFDM based waveform and/or an SC-QAM based waveform) may be a default waveform for sidelink SSBs for a higher frequency band (e.g., a frequency band associated with an operating frequency greater than 60 GHz).

In some aspects, the first UE 610 may receive an indication of an update to the sidelink resource pool configuration. For example, one or more waveforms that are configured for a resource pool may be updated (e.g., by the WCD 605 or by another device). The update may indicate a modification to the multiple waveforms configured for the sidelink resource pool. For example, the update may change one or more waveforms that are available for use when communicating using the sidelink resource pool. For example, the update may indicate a modification to a waveform associated with the sidelink resource pool (e.g., may change a type of waveform to be used when communicating via the sidelink resource pool, may add an additional waveform that is available to be used when communicating via the sidelink resource pool, and/or may remove a waveform from waveform(s) available to be used when communicating via the sidelink resource pool, among other examples). The first UE 610 may communicate, via the sidelink resource pool, in accordance with the modification to the waveform(s) (e.g., using waveform type(s) indicated by the update or modification).

In some aspects, the first UE 610 may receive the indication of the update to the sidelink resource pool configuration via a Uu interface RRC communication. For example, when the WCD 605 is a network entity, the WCD 605 may transmit, and the first UE 610 may receive, a Uu interface RRC communication including the update to the sidelink resource pool configuration. As another example, the first UE 610 may receive the indication of the update to the sidelink resource pool configuration via a Uu interface MAC-CE communication. For example, when the WCD 605 is a network entity, the WCD 605 may transmit, and the first UE 610 may receive, a Uu interface MAC-CE communication including the update to the sidelink resource pool configuration. As another example, the first UE 610 may receive the indication of the update to the sidelink resource pool configuration via Uu interface control information (e.g., DCI). For example, when the WCD 605 is a network entity, the WCD 605 may transmit, and the first UE 610 may receive, DCI including the update to the sidelink resource pool configuration.

In some other aspects, the WCD 605 may be a UE (e.g., a UE 120). In such examples, the first UE 610 may receive the indication of the update to the sidelink resource pool configuration via a PC5 interface RRC communication (e.g., a sidelink RRC communication). For example, the WCD 605 may transmit, and the first UE 610 may receive, a PC5 interface RRC communication (e.g., a sidelink RRC communication) including the update to the sidelink resource pool configuration. As another example, the first UE 610 may receive the indication of the update to the sidelink resource pool configuration via a PC5 interface MAC-CE communication (e.g., a sidelink MAC-CE communication). For example, the WCD 605 may transmit, and the first UE 610 may receive, a PC5 interface MAC-CE communication (e.g., a sidelink MAC-CE communication) including the update to the sidelink resource pool configuration. As another example, the first UE 610 may receive the indication of the update to the sidelink resource pool configuration via PC5 interface control information (e.g., SCI). For example, the WCD 605 may transmit, and the first UE 610 may receive, SCI including the update to the sidelink resource pool configuration.

In some aspects, as shown by reference number 630, the first UE 610 (and/or the second UE 615) may receive a communication indicating that a particular waveform (e.g., from the waveforms configured for the sidelink resource pool) is to be used by the first UE 610 (and/or the second UE 615) when communicating via the sidelink resource pool. For example, the sidelink resource pool configuration may indicate that there are multiple (e.g., two or more) waveforms available to be used when communicating via the sidelink resource pool. The first UE 610 (and/or the second UE 615) may receive a communication indicating that a first waveform, from the multiple waveforms, is to be used when communicating via the sidelink resource pool. In some aspects, the WCD 605 may transmit the communication indicating that a particular waveform (e.g., from the waveforms configured for the sidelink resource pool) is to be used by the first UE 610 (and/or the second UE 615) when communicating via the sidelink resource pool. In some aspects, the WCD 605 may transmit the communication to the first UE 610 and the second UE 615. In some other aspects, the WCD 605 may transmit the communication to the first UE 610. The first UE 610 may transmit, and the second UE 615 may receive, an indication of the particular waveform that is to be used when communicating via the sidelink resource pool (e.g., the first UE 610 may forward the indication of the waveform to be used). The first UE 610 (and/or the second UE 615) may receive the communication using Layer 3 signaling (e.g., RRC signaling), Layer 2 signaling (e.g., MAC signaling), and/or Layer 1 signaling (e.g., control information signaling), among other examples. In some aspects, such as when the WCD 605 is a network entity, the first UE 610 and/or the second UE 615 may receive the communication via a Uu interface. In some other aspects, such as when the WCD 605 is a UE, the first UE 610 and/or the second UE 615 may receive the communication via a PC5 interface.

The first UE 610 and/or the second UE 615 may continue to use the waveform indicated by the communication for sidelink signals associated with the sidelink resource pool until another communication indicating another waveform to be used is received, until a condition associated with the sidelink channel is detected (e.g., as explained in more detail elsewhere herein), and/or until a certain amount of time has passed from receiving the communication, among other examples. For example, the first UE 610 and/or the second UE 615 may use the waveform indicated by the communication (e.g., received from the WCD 605) for a certain amount of time (e.g., where the amount of time may be configured by the resource pool configuration and/or may be defined, or otherwise fixed, by a wireless communication standard, such as the 3GPP). In some aspects, after the amount of time from receiving the communication passes, the first UE 610 and/or the second UE 615 may use a default waveform for the sidelink resource pool (e.g., if no other communications indicating which waveform is to be used for the sidelink resource pool have been received by the first UE 610 and/or the second UE 615). As another example, the first UE 610 and/or the second UE 615 may continue to use the waveform indicated by the communication for sidelink signals associated with the sidelink resource pool until another communication indicating another waveform to be used is received by the first UE 610 and/or the second UE 615. Additionally, or alternatively, the first UE 610 and/or the second UE 615 may continue to use the waveform indicated by the communication for sidelink signals associated with the sidelink resource pool until another communication indicating another waveform to be used is received by the first UE 610 and/or the second UE 615 or until a condition associated with switching waveform type is detected by the first UE 610 and/or the second UE 615.

In some aspects, the first UE 610 and/or the second UE 615 may receive an indication of a waveform to be used with a particular cast type. Example cast types may include unicast (e.g., peer-to-peer or one-to-one), groupcast (e.g., one-to-many), and/or broadcast (e.g., one-to-all), among other examples. For example, a condition associated with a use of a particular waveform may include a cast type associated with a sidelink signal. Accordingly, a waveform may be selected based on the cast type associated with the sidelink signal. In other words, a condition may indicate that if a particular cast type is used, then a waveform associated with the particular cast type is used. For example, the first waveform may be used based at least in part on the first waveform being associated with the cast type. In other words, the first UE 610 and/or the second UE 615 may be configured to use a particular waveform for a particular cast type. For example, a first one or more waveforms, from the multiple waveforms available to be used on the sidelink channel, may be associated with a first cast type (e.g., unicast). A second one or more waveforms, from the multiple waveforms, may be associated with a second cast type (e.g., broadcast). In some aspects, an association of one or more waveforms to respective cast types may be included in the resource pool configuration and/or another configuration. In some aspects, the first UE 610 and/or the second UE 615 may receive an indication of the association of one or more waveforms to respective cast types from the WCD 605. For example, the WCD 605 may indicate a type of waveform based at least on a cast type (e.g., where all UEs communicating using the cast type are to use the indicated waveform).

For example, the first UE 610 may receive an indication of respective cast types associated with waveforms of the multiple waveforms (e.g., that are configured for the sidelink channel and/or the sidelink resource pool). In some aspects, the association of one or more waveforms to respective cast types may be associated with the sidelink channel (e.g., may be associated with all sidelink resource pools configured for the first UE 610 and/or the second UE 615). For example, the respective cast types may be associated with all sidelink resource pools including the sidelink resource pool. In some other aspects, the association of one or more waveforms to respective cast types may be associated with a particular sidelink resource pool (e.g., the association or mapping of cast type to waveform(s) may be included in a sidelink resource pool configuration). For example, the respective cast types may be specific to the sidelink resource pool.

In some aspects, the first UE 610 and/or the second UE 615 may receive the indication of a waveform to be used with a particular cast type via an RRC communication (e.g., a Uu interface RRC communication or a PC5 interface RRC communication). As another example, the first UE 610 and/or the second UE 615 may receive the indication of a waveform to be used with a particular cast type via a MAC-CE communication (e.g., a Uu interface MAC-CE communication or a PC5 interface MAC-CE communication). As another example, the first UE 610 and/or the second UE 615 may receive the indication of a waveform to be used with a particular cast type via control information (e.g., DCI or SCI).

In some aspects, as shown by reference number 635, the first UE 610 and the second UE 615 may negotiate or indicate a particular waveform (e.g., from multiple waveforms configured for the sidelink resource pool) that is to be used by the first UE 610 and the second UE 615 when communicating via the sidelink resource pool. For example, the first UE 610 may receive, from the second UE 615, a communication indicating that a particular waveform is to be used by the first UE 610 and the second UE 615. As another example, the first UE 610 may transmit, to the second UE 615, a communication indicating that a particular waveform is to be used by the first UE 610 and the second UE 615. For example, the sidelink resource pool configuration may indicate multiple (e.g., two or more) waveforms that are available to be used for communications associated with the sidelink resource pool. The first UE 610 and/or the second UE 615 may transmit an indication of a waveform, from the multiple waveforms, that is to be used for sidelink communications between the first UE 610 and the second UE 615 via the sidelink resource pool. For example, the first UE 610 and/or the second UE 615 may determine or select the waveform based at least in part on a condition associated with the sidelink channel (e.g., as described in more detail elsewhere herein). In some aspects, the first UE 610 may transmit, to the second UE 615, an indication of a waveform to be used when the first UE 610 transmits and/or receives communications via the sidelink resource pool. Additionally, or alternatively, the second UE 615 may transmit, to the first UE 610, an indication of a waveform to be used when the second UE 615 transmits and/or receives communications via the sidelink resource pool. The first UE 610 and/or the second UE 615 may transmit the indication of the waveform, from the multiple waveforms, that is to be used for sidelink communications between the first UE 610 and the second UE 615 via Layer 3 signaling (e.g., sidelink RRC signaling), Layer 2 signaling (e.g., sidelink MAC signaling), and/or Layer 1 signaling (e.g., sidelink control information signaling), among other examples.

In some aspects, the first UE 610 may receive, from the second UE 615, a sidelink RRC communication indicating that the first waveform is to be used by the first UE as part of an RRC connection establishment procedure with the second UE. For example, the first UE 610 and the second UE 615 may negotiate the waveform to be used for the sidelink resource pool as part of an RRC connection establishment procedure. In some aspects, the first UE 610 may receive, from the second UE 615, an indication of a capability of the second UE 615 (e.g., in a UECapabilityInformationSidelink communication). The capability of the second UE 615 may be associated with one or more waveforms that are supported by the second UE for sidelink communications and/or for sidelink communications associated with the sidelink resource pool. In some aspects, the first UE 610 may select a waveform (e.g., from the one or more waveforms supported by the second UE 615). The first UE 610 may transmit, and the second UE 615 may receive, a sidelink RRC communication (e.g., an RRCReconfigurationSidelink communication or another sidelink RRC communication) indicating the selected waveform. The second UE 615 may transmit, and the first UE 610 may receive, an indication (e.g., in an RRCReconfigurationCompleteSidelink communication or another sidelink RRC communication) of whether the second UE 615 has configured the selected waveform to be used for sidelink communications between the first UE 610 and the second UE 615 via the sidelink resource pool. In this way, the first UE 610 and the second UE 615 may negotiate the waveform to be used for the sidelink resource pool as part of the RRC connection establishment procedure. For example, the first UE 610 and the second UE 615 may negotiate the waveform to be used for the sidelink resource pool as part of a PC5 RRC access stratum (AS) layer configuration procedure.

In some aspects, the first UE 610 and/or the second UE 615 may use a particular waveform based at least in part on a condition associated with the sidelink channel and/or the sidelink resource pool. For example, the first UE 610 and/or the second UE 615 may switch between two (or more) waveforms for the sidelink resource pool based at least in part on detecting one or more conditions. In some aspects, the condition may include a cast type of a sidelink signal being communicated (e.g., a given cast type may be associated with a given waveform, as explained in more detail elsewhere herein). In some aspects, the condition may be based at least in part on a requirement or a threshold associated with communications via the sidelink channel and/or the sidelink resource pool (e.g., a quality of service (QoS) requirement, a block error rate (BLER) requirement, and/or a bit error rate (BER) requirement, among other examples). Accordingly, the waveform may be selected based at least in part on whether a measurement (e.g., performed by the UE) satisfies a threshold. For example, if a measured BLER or BER satisfies a threshold, then the first UE 610 and the second UE 615 may use a first waveform for sidelink communications. If the measured BLER or BER does not satisfy the threshold, then the first UE 610 and the second UE 615 may use a second waveform for sidelink communications. The requirements and/or thresholds may be negotiated and/or agreed upon by the first UE 610 and the second UE 615.

In some aspects, the condition may be based at least in part on a measurement associated with the sidelink channel and/or the sidelink resource pool. For example, as shown by reference number 640, the first UE 610 may measure a parameter associated with the sidelink channel. The parameter may include a BLER, a BER, a channel quality parameter, a CQI, a signal-to-interference-plus-noise ratio (SINR), an RSRP, an RSRQ, and/or a pathloss value, among other examples. In some aspects, both the first UE 610 and the second UE 615 may measure the parameter. In some aspects, one UE (e.g., from the first UE 610 and the second UE 615) may measure the parameter and may transmit an indication of the measurement to the other UE (e.g., from the first UE 610 and the second UE 615). In some aspects, a UE (e.g., from the first UE 610 and the second UE 615) that is to receive a sidelink communication may measure the parameter and may transmit an indication of the measurement to the other UE (e.g., the transmitting UE in this example). In some aspects, the first UE 610 may measure the parameter associated with the sidelink channel (e.g., and the waveform used to communicate by the first UE 610 via the sidelink resource pool may be based at least in part on the measurement of the parameter and the condition, as explained in more detail elsewhere herein). Additionally, or alternatively, the first UE 610 may receive, from the second UE 615, an indication of a measurement of a parameter associated with the sidelink channel (e.g., and the waveform used to communicate by the first UE 610 via the sidelink resource pool may be based at least in part on the measurement of the parameter and the condition, as explained in more detail elsewhere herein).

For example, in some aspects, the condition may include a BLER based condition and/or a BER based condition. The first UE 610 and the second UE 615 may switch between different waveforms based at least in part on BLER measurements and/or BER measurements (e.g., may use a first waveform when the measurements satisfy a threshold and may use a second waveform when the measurements do not satisfy the threshold). Accordingly, the waveform may be selected based at least in part on whether a BLER measurement (e.g., performed by the UE) satisfies a threshold. Additionally, or alternatively, the condition may include a channel quality based condition, a CQI based condition, an MCS based condition, and/or an SINR based condition, among other examples. For example, if an MCS index value associated with an MCS used by the first UE 610 and the second UE 615 satisfies a threshold, then the first UE 610 and the second UE 615 may use a first waveform. If the MCS index value associated with an MCS used by the first UE 610 and the second UE 615 does not satisfy the threshold, then the first UE 610 and the second UE 615 may use a second waveform. Accordingly, the waveform may be selected based at least in part on whether an MCS index value associated with an MCS used by the first UE 610 and the second UE 615 satisfies a threshold. As another example, if a measured SINR of the sidelink channel satisfies a threshold, then the first UE 610 and the second UE 615 may use a first waveform. If the measured SINR of the sidelink channel satisfies a threshold, then the first UE 610 and the second UE 615 may use a second waveform. Accordingly, the waveform may be selected based at least in part on whether an SINR measurement (e.g., performed by the UE) satisfies a threshold. Additionally, or alternatively, the condition may include an RSRP based condition, an RSRQ based condition, and/or a pathloss based condition. For example, if a measured RSRP, RSRQ, or pathloss associated with the sidelink channel satisfies a threshold, then the first UE 610 and the second UE 615 may use a first waveform. If the measured RSRP, RSRQ, or pathloss associated with the sidelink channel does not satisfy the threshold, then the first UE 610 and the second UE 615 may use a second waveform. Accordingly, the waveform may be selected based at least in part on whether a RSRP, RSRQ, and/or pathloss measurement(s) (e.g., performed by the UE) satisfies a threshold.

In some aspects, as shown by reference number 645, the first UE 610 may select a waveform to be used for the sidelink resource pool based at least in part on the condition. For example, the first UE 610 may select the waveform (e.g., from multiple waveforms configured for the sidelink resource pool) based at least in part on a cast type to be used, a measurement associated with the sidelink channel, and/or another condition (e.g., as described elsewhere herein). The second UE 615 may select the waveform to be used for the sidelink resource pool based at least in part on the condition in a similar manner. In this way, the first UE 610 and the second UE 615 may be synchronized as to the waveform to be used for the sidelink resource pool. In some aspects, the first UE 610 and/or the second UE 615 may select the waveform (e.g., from multiple waveforms configured for the sidelink resource pool) based at least in part on the condition and without receiving an indication that the waveform is to be used (e.g., from the WCD 605 or from another device). In some aspects, the first UE 610 and/or the second UE 615 may select the waveform (e.g., from multiple waveforms configured for the sidelink resource pool) based at least in part on the condition and based at least in part on receiving an indication that the waveform is to be used (e.g., the indication that the waveform is to be used may indicate the condition and the UEs may select the waveform based at least in part on detecting the condition).

In some aspects, the first UE 610 may select the waveform based at least in part on receiving a sidelink signal, from the second UE 615, that uses the waveform. For example, the first UE 610 may receive, from the second UE and prior to communicating a first sidelink signal, a second sidelink signal using the waveform. The first UE 610 may select the waveform based at least in part on receiving the second sidelink signal using the waveform. For example, for communications between two UEs where the two UEs will exchange multiple signals or operate in a full-duplex (FD) manner, one of the UEs may select the waveform (e.g., may start a transmission using the waveform) and the other UE may (e.g., may have to) use the same waveform (e.g., for receiving and transmitting via the sidelink resource pool). In some aspects, the first UE 610 may also use the waveform for communications with other UEs via the sidelink resource pool.

In some aspects, a sidelink signal transmitted by the first UE 610 (e.g., as described in more detail below in connection with reference number 650) may be associated with a sidelink configured grant configuration. For example, the first UE 610 may receive a sidelink configured grant configuration. For example, the first UE 610 may receive the sidelink configured grant configuration via an RRC message transmitted by the WCD 605. The sidelink configured grant configuration may indicate a resource allocation associated with configured grant sidelink communications (e.g., in a time domain, frequency domain, spatial domain, and/or code domain) and a periodicity at which the resource allocation is repeated, resulting in periodically reoccurring scheduled configured occasions for the first UE 610. In some examples, the sidelink configured grant configuration may identify a resource pool (e.g., the sidelink resource pool) or multiple resource pools that are available to the first UE 610 for a sidelink configured grant transmission. In some aspects, the sidelink configured grant configuration may indicate that a particular waveform is to be used for signals (e.g., for sidelink transmissions) associated with the sidelink configured grant configuration. In some aspects, the second UE 615 may be unaware of the sidelink configured grant configuration associated with the first UE 610. Therefore, the first UE 610 may transmit, to the second UE 615, an indication that the waveform is to be used for signals associated with the sidelink configured grant configuration. In this way, the second UE 615 may be aware that the first UE 610 may use the waveform when the first UE 610 transmits a sidelink signal associated with the sidelink configured grant configuration.

As shown by reference number 650, the first UE 610 and the second UE 615 may communicate using a first waveform (e.g., from the multiple waveforms available to be used on the sidelink channel). For example, the first UE 610 may transmit, and the second UE 615 may receive, one or more sidelink signals using the first waveform. Additionally, or alternatively, the second UE 615 may transmit, and the first UE 610 may receive, one or more sidelink signals using the first waveform. In some aspects, the waveform may be based at least in part on a cast type associated with the one or more signals, a condition detected by the first UE 610 or the second UE 615, an indication received by the first UE 610 and/or the second UE 615 (e.g., from the WCD 605 or another device), or a configured grant configuration associated with the one or more signals, among other examples (e.g., as explained in more detail elsewhere herein).

In some aspects, the first UE 610 may transmit, and the second UE 615 may receive, a sidelink communication using the selected waveform. The first UE 610 and the second UE 615 may communicate (e.g., transmit and/or receive) the sidelink communication and any retransmissions of the sidelink communication using the selected waveform. For example, the first UE 610 and the second UE 615 may be expected to use the same waveform across an initial transmission and any reservations associated with the initial transmission. For example, the first UE 610 and the second UE 615 may be expected to use the same waveform for an initial transmission of a transport block (TB) and any retransmissions of the TB.

As a result, the first UE 610 may be configured with multiple waveforms that are available to be used for the communication of sidelink signals associated with a sidelink resource pool. Additionally, the first UE 610 may be enabled to select and/or identify a waveform, from the multiple waveforms, to be used for a given sidelink communication. Enabling the use of multiple waveforms may improve sidelink communication performance by enabling the first UE 610 to flexibly use different waveforms at different times and/or when experiencing different conditions associated with the sidelink channel. For example, at a first time, the first UE 610 may transmit and/or receive sidelink communications using a first waveform to reduce a PAPR. At a second time, the first UE 610 may transmit and/or receive sidelink communications using a second waveform for increased SCS and/or enablement of higher order MIMO communications, among other examples. Additionally, some techniques and apparatuses described herein provide mechanisms to enable UEs (e.g., the first UE 610 and/or the second UE 615) communicating on the sidelink channel to synchronize which waveform, from multiple waveforms, is to be used at a given time and/or for a given sidelink communication (e.g., such as in scenarios where one or more of the UEs are not connected to a network entity).

As indicated above, FIG. 6 is provided as an example. Other examples may differ from what is described with respect to FIG. 6.

FIG. 7 is a diagram illustrating an example process 700 performed, for example, by a first UE, in accordance with the present disclosure. Example process 700 is an example where the UE (e.g., a UE 120, the first UE 610, and/or the second UE 615) performs operations associated with enabling multiple waveforms for use in sidelink.

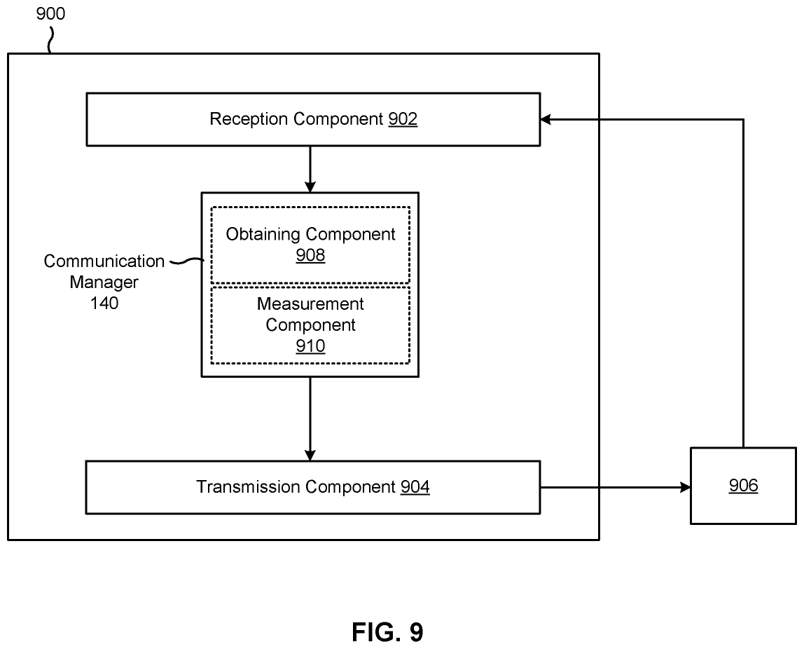

As shown in FIG. 7, in some aspects, process 700 may include obtaining a sidelink resource pool configuration indicating multiple waveforms that are available for use for sidelink signals associated with a sidelink resource pool (block 710). For example, the UE (e.g., using communication manager 140, reception component 902, and/or obtaining component 908, depicted in FIG. 9) may obtain a sidelink resource pool configuration indicating multiple waveforms that are available for use for sidelink signals associated with a sidelink resource pool, as described above.

As further shown in FIG. 7, in some aspects, process 700 may include communicating, with a second UE and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE (block 720). For example, the UE (e.g., using communication manager 140, reception component 902, and/or transmission component 904, depicted in FIG. 9) may communicate, with a second UE and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE, as described above.

Process 700 may include additional aspects, such as any single aspect or any combination of aspects described below and/or in connection with one or more other processes described elsewhere herein.

In a first aspect, obtaining the sidelink resource pool configuration includes receiving the sidelink resource pool configuration from a network entity.

In a second aspect, alone or in combination with the first aspect, obtaining the sidelink resource pool configuration includes receiving the sidelink resource pool configuration from the second UE or another UE.

In a third aspect, alone or in combination with one or more of the first and second aspects, process 700 includes communicating, with the second UE or another UE and prior to obtaining the sidelink resource pool configuration, a second sidelink signal using a default waveform.

In a fourth aspect, alone or in combination with one or more of the first through third aspects, the default waveform is based at least in part on a frequency band used to communicate the second sidelink signal.

In a fifth aspect, alone or in combination with one or more of the first through fourth aspects, the second sidelink signal includes a sidelink synchronization signal block (SSB).

In a sixth aspect, alone or in combination with one or more of the first through fifth aspects, process 700 includes receiving an indication of one or more default waveforms, including the default waveform, to be used by the first UE.

In a seventh aspect, alone or in combination with one or more of the first through sixth aspects, the one or more default waveforms include a first default waveform associated with a first frequency band and a second default waveform associated with a second frequency band.

In an eighth aspect, alone or in combination with one or more of the first through seventh aspects, process 700 includes receiving an indication of an update to the sidelink resource pool configuration, wherein the update indicates a modification to the first waveform, and wherein communicating the first sidelink signal includes communicating in accordance with the modification to the first waveform.

In a ninth aspect, alone or in combination with one or more of the first through eighth aspects, the update is included in a Uu interface RRC communication.

In a tenth aspect, alone or in combination with one or more of the first through ninth aspects, the update is included in a PC5 interface RRC communication.

In an eleventh aspect, alone or in combination with one or more of the first through tenth aspects, the update is included in a Uu interface MAC-CE communication or a PC5 interface MAC-CE communication.

In a twelfth aspect, alone or in combination with one or more of the first through eleventh aspects, the update is included in downlink control information or sidelink control information.

In a thirteenth aspect, alone or in combination with one or more of the first through twelfth aspects, receiving the communication indicating that the first waveform is to be used by the first UE includes receiving the communication from a network entity.

In a fourteenth aspect, alone or in combination with one or more of the first through thirteenth aspects, receiving the communication indicating that the first waveform is to be used by the first UE includes receiving the communication from the second UE or another UE.

In a fifteenth aspect, alone or in combination with one or more of the first through fourteenth aspects, the condition associated with the sidelink channel includes at least one of a BLER based condition, a BER based condition, a channel quality based condition, a CQI based condition, an MCS based condition, an SINR based condition, an RSRP based condition, an RSRQ based condition, or a pathloss based condition.

In a sixteenth aspect, alone or in combination with one or more of the first through fifteenth aspects, process 700 includes measuring a parameter associated with the sidelink channel, wherein the first waveform is based at least in part on the measurement of the parameter and the condition.

In a seventeenth aspect, alone or in combination with one or more of the first through sixteenth aspects, process 700 includes receiving, from the second UE, an indication of a measurement of a parameter associated with the sidelink channel, wherein the first waveform is based at least in part on the measurement of the parameter and the condition.

In an eighteenth aspect, alone or in combination with one or more of the first through seventeenth aspects, the condition includes a cast type associated with the first sidelink signal, and the first waveform is used based at least in part on the first waveform being associated with the cast type.

In a nineteenth aspect, alone or in combination with one or more of the first through eighteenth aspects, the cast type includes at least one of unicast, groupcast, or broadcast.

In a twentieth aspect, alone or in combination with one or more of the first through nineteenth aspects, a first one or more waveforms, from the multiple waveforms, are associated with a first cast type, and a second one or more waveforms, from the multiple waveforms, are associated with a second cast type.

In a twenty-first aspect, alone or in combination with one or more of the first through twentieth aspects, process 700 includes receiving an indication of respective cast types associated with waveforms of the multiple waveforms, and communicating the first sidelink signal using the first waveform is based at least in part on the first sidelink signal being associated with a cast type associated with the first waveform.

In a twenty-second aspect, alone or in combination with one or more of the first through twenty-first aspects, the respective cast types are associated with all sidelink resource pools including the sidelink resource pool.

In a twenty-third aspect, alone or in combination with one or more of the first through twenty-second aspects, the respective cast types are specific to the sidelink resource pool.

In a twenty-fourth aspect, alone or in combination with one or more of the first through twenty-third aspects, receiving the communication indicating that the first waveform is to be used by the first UE includes receiving, from the second UE, a sidelink RRC communication indicating that the first waveform is to be used by the first UE as part of an RRC connection establishment procedure with the second UE.

In a twenty-fifth aspect, alone or in combination with one or more of the first through twenty-fourth aspects, the first sidelink signal is associated with a sidelink configured grant, and process 700 includes receiving a sidelink configured grant configuration, associated with the sidelink configured grant, indicating that the first waveform is to be used for signals associated with the sidelink configured grant configuration.

In a twenty-sixth aspect, alone or in combination with one or more of the first through twenty-fifth aspects, process 700 includes transmitting, to the second UE, an indication that the first waveform is to be used for signals associated with the sidelink configured grant configuration.

In a twenty-seventh aspect, alone or in combination with one or more of the first through twenty-sixth aspects, receiving the communication indicating that the first waveform is to be used by the first UE includes receiving, from the second UE and prior to communicating the first sidelink signal, a second sidelink signal using the first waveform, and communicating the first sidelink signal includes transmitting, to the second UE, the first sidelink signal using the first waveform based at least in part on receiving the second sidelink signal using the first waveform.

In a twenty-eighth aspect, alone or in combination with one or more of the first through twenty-seventh aspects, communicating the first sidelink signal includes communicating the first sidelink signal and any retransmissions of the first sidelink signal using the first waveform.

In a twenty-ninth aspect, alone or in combination with one or more of the first through twenty-eighth aspects, process 700 includes communicating, with the second UE or another UE, a second sidelink signal using a second waveform from the multiple waveforms.

In a thirtieth aspect, alone or in combination with one or more of the first through twenty-ninth aspects, the multiple waveforms include at least one of a CP-OFDM based waveform, an SC based waveform, a DFT-s-OFDM based waveform, or an SC-QAM based waveform.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a wireless communication device, in accordance with the present disclosure. Example process 800 is an example where the wireless communication device (e.g., the WCD 605, a UE 120, a base station 110, a network entity, a CU, a DU, and/or an RU) performs operations associated with enabling multiple waveforms for use in sidelink.

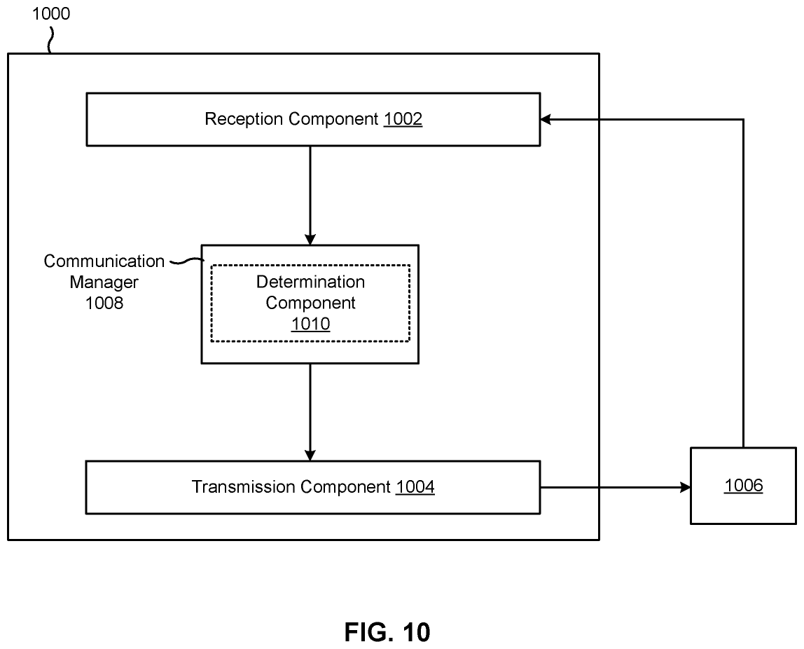

As shown in FIG. 8, in some aspects, process 800 may include transmitting, to a first UE, a sidelink resource pool configuration indicating multiple waveforms that are available for use for sidelink signals associated with a sidelink resource pool (block 810). For example, the wireless communication device (e.g., using communication manager 1008 and/or transmission component 1004, depicted in FIG. 10) may transmit, to a first UE, a sidelink resource pool configuration indicating multiple waveforms that are available for use for sidelink signals associated with a sidelink resource pool, as described above.

As further shown in FIG. 8, in some aspects, process 800 may include transmitting, to the first UE, an indication of a first waveform, from the multiple waveforms, that is to be used by the first UE for sidelink communications associated with the sidelink resource pool (block 820). For example, the wireless communication device (e.g., using communication manager 1008 and/or transmission component 1004, depicted in FIG. 10) may transmit, to the first UE, an indication of a first waveform, from the multiple waveforms, that is to be used by the first UE for sidelink communications associated with the sidelink resource pool, as described above.

Process 800 may include additional aspects, such as any single aspect or any combination of aspects described below and/or in connection with one or more other processes described elsewhere herein.

In a first aspect, process 800 includes transmitting an indication of one or more default waveforms to be used by the first UE.

In a second aspect, alone or in combination with the first aspect, the one or more default waveforms include a first default waveform associated with a first frequency band and a second default waveform associated with a second frequency band.

In a third aspect, alone or in combination with one or more of the first and second aspects, process 800 includes transmitting, to the first UE, an indication of an update to the sidelink resource pool configuration, wherein the update indications a modification to the multiple waveforms.

In a fourth aspect, alone or in combination with one or more of the first through third aspects, the wireless communication device includes a network entity, and the update is included in a Uu interface RRC communication.

In a fifth aspect, alone or in combination with one or more of the first through fourth aspects, the wireless communication device includes a second UE, and the update is included in a PC5 interface RRC communication.

In a sixth aspect, alone or in combination with one or more of the first through fifth aspects, the update is included in a Uu interface MAC-CE communication or a PC5 interface MAC-CE communication.

In a seventh aspect, alone or in combination with one or more of the first through sixth aspects, the update is included in downlink control information or sidelink control information.

In an eighth aspect, alone or in combination with one or more of the first through seventh aspects, the sidelink resource pool configuration indicates one or more conditions associated with a use of the multiple waveforms by the first UE.

In a ninth aspect, alone or in combination with one or more of the first through eighth aspects, the one or more conditions include at least one of a BLER based condition, a BER based condition, a channel quality based condition, a CQI based condition, an MCS based condition, an SINR based condition, an RSRP based condition, an RSRQ based condition, or a pathloss based condition.

In a tenth aspect, alone or in combination with one or more of the first through ninth aspects, the one or more conditions include a cast type associated with a sidelink communication.

In an eleventh aspect, alone or in combination with one or more of the first through tenth aspects, the cast type includes at least one of unicast, groupcast, or broadcast.

In a twelfth aspect, alone or in combination with one or more of the first through eleventh aspects, a first one or more waveforms, from the multiple waveforms, are associated with a first cast type, and a second one or more waveforms, from the multiple waveforms, are associated with a second cast type.

In a thirteenth aspect, alone or in combination with one or more of the first through twelfth aspects, process 800 includes transmitting, to the first UE, an indication of respective cast types associated with waveforms of the multiple waveforms.

In a fourteenth aspect, alone or in combination with one or more of the first through thirteenth aspects, the respective cast types are associated with all sidelink resource pools including the sidelink resource pool.

In a fifteenth aspect, alone or in combination with one or more of the first through fourteenth aspects, the respective cast types are specific to the sidelink resource pool.

In a sixteenth aspect, alone or in combination with one or more of the first through fifteenth aspects, the wireless communication device is a second UE, and transmitting the indication that the first waveform is to be used by the first UE includes transmitting, to the first UE, a sidelink RRC communication indicating that the first waveform is to be used by the first UE as part of an RRC connection establishment procedure with the first UE.

In a seventeenth aspect, alone or in combination with one or more of the first through sixteenth aspects, process 800 includes transmitting, to the first UE, a sidelink configured grant configuration, associated with a sidelink configured grant, indicating that the first waveform is to be used for signals associated with the sidelink configured grant configuration.

In an eighteenth aspect, alone or in combination with one or more of the first through seventeenth aspects, the first waveform is to be used for an initial sidelink transmission and any retransmissions of the initial sidelink transmission.

In a nineteenth aspect, alone or in combination with one or more of the first through eighteenth aspects, the multiple waveforms include at least one of a CP-OFDM based waveform, an SC based waveform, a DFT-s-OFDM based waveform, or an SC-QAM based waveform.

In a twentieth aspect, alone or in combination with one or more of the first through nineteenth aspects, the wireless communication device is a network entity.

In a twenty-first aspect, alone or in combination with one or more of the first through twentieth aspects, the wireless communication device is a second UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include the communication manager 140. The communication manager 140 may include one or more of an obtaining component 908, and/or a measurement component 910, among other examples.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 and/or the obtaining component 908 may obtain a sidelink resource pool configuration indicating multiple waveforms that are available for use for sidelink signals associated with a sidelink resource pool. The reception component 902 or the transmission component 904 may communicate, with a second UE and via a sidelink channel, a first sidelink signal associated with the sidelink resource pool, wherein the first sidelink signal uses a first waveform from the multiple waveforms, and wherein the first waveform is used based at least in part on at least one of a condition associated with the sidelink channel, or receiving a communication indicating that the first waveform is to be used by the first UE.

The reception component 902 or the transmission component 904 may communicate, with the second UE or another UE and prior to obtaining the sidelink resource pool configuration, a second sidelink signal using a default waveform.

The reception component 902 may receive an indication of one or more default waveforms, including the default waveform, to be used by the first UE.

The reception component 902 may receive an indication of an update to the sidelink resource pool configuration, wherein the update indicates a modification to the first waveform, and wherein communicating the first sidelink signal includes communicating in accordance with the modification to the first waveform.

The measurement component 910 may measure a parameter associated with the sidelink channel wherein the first waveform is based at least in part on the measurement of the parameter and the condition.

The reception component 902 may receive, from the second UE, an indication of a measurement of a parameter associated with the sidelink channel, wherein the first waveform is based at least in part on the measurement of the parameter and the condition.

The reception component 902 may receive an indication of respective cast types associated with waveforms of the multiple waveforms, and communicating the first sidelink signal using the first waveform is based at least in part on the first sidelink signal being associated with a cast type associated with the first waveform.

The transmission component 904 may transmit, to the second UE, an indication that the first waveform is to be used for signals associated with the sidelink configured grant configuration.

The reception component 902 or the transmission component 904 may communicate, with the second UE or another UE, a second sidelink signal using a second waveform from the multiple waveforms.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a wireless communication device, or a wireless communication device may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008. In some aspects, the communication manager 1008 may be, may include, may be similar to, or may include one or more components of, the communication manager 140. As another example, the communication manager 1008 may be, may include, may be similar to, or may include one or more components of, the communication manager 150. The communication manager 1008 may include a determination component 1010, among other examples.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the wireless communication device described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the wireless communication device described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the wireless communication device described in connection with FIG. 2. In some aspects, the transmission component 1004 may be co-located with the reception component 1002 in a transceiver.

The transmission component 1004 may transmit, to a first UE, a sidelink resource pool configuration indicating multiple waveforms that are available for use for sidelink signals associated with a sidelink resource pool. The transmission component 1004 may transmit, to the first UE, an indication of a first waveform, from the multiple waveforms, that is to be used by the first UE for sidelink communications associated with the sidelink resource pool.

The determination component 1010 may determine the sidelink resource pool configuration. The determination component 1010 may determine the sidelink resource pool configuration based at least in part on a capability of the first UE associated with supporting multiple waveforms for sidelink communications.

The transmission component 1004 may transmit an indication of one or more default waveforms to be used by the first UE.

The transmission component 1004 may transmit, to the first UE, an indication of an update to the sidelink resource pool configuration, wherein the update indications a modification to the multiple waveforms.

The transmission component 1004 may transmit, to the first UE, an indication of respective cast types associated with waveforms of the multiple waveforms.

The transmission component 1004 may transmit, to the first UE, a sidelink configured grant configuration, associated with a sidelink configured grant, indicating that the first waveform is to be used for signals associated with the sidelink configured grant configuration.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a first user equipment (UE), comprising: obtaining a sidelink resource pool configuration indicating multiple waveforms that are available for use for sidelink signals associated with a sidelink resource pool; and communicating, with a second UE and via a sidelink channel, a first sidelink signal associated with the sidelink resource pool, wherein the first sidelink signal uses a first waveform from the multiple waveforms, and wherein the first waveform is used based at least in part on at least one of: a condition associated with the sidelink channel, or receiving a communication indicating that the first waveform is to be used by the first UE.
Aspect 2: The method of Aspect 1, wherein obtaining the sidelink resource pool configuration comprises: receiving the sidelink resource pool configuration from a network entity.
Aspect 3: The method of any of Aspects 1-2, wherein obtaining the sidelink resource pool configuration comprises: receiving the sidelink resource pool configuration from the second UE or another UE.
Aspect 4: The method of any of Aspects 1-3, further comprising: communicating, with the second UE or another UE and prior to obtaining the sidelink resource pool configuration, a second sidelink signal using a default waveform.
Aspect 5: The method of Aspect 4, wherein the default waveform is based at least in part on a frequency band used to communicate the second sidelink signal.
Aspect 6: The method of any of Aspects 4-5, wherein the second sidelink signal includes a sidelink synchronization signal block (SSB).
Aspect 7: The method of any of Aspects 4-6, further comprising: receiving an indication of one or more default waveforms, including the default waveform, to be used by the first UE.
Aspect 8: The method of Aspect 7, wherein the one or more default waveforms include a first default waveform associated with a first frequency band and a second default waveform associated with a second frequency band.
Aspect 9: The method of any of Aspects 1-8, further comprising: receiving an indication of an update to the sidelink resource pool configuration, wherein the update indicates a modification to the first waveform, and wherein communicating the first sidelink signal includes communicating in accordance with the modification to the first waveform.
Aspect 10: The method of Aspect 9, wherein the update is included in a Uu interface radio resource control (RRC) communication.
Aspect 11: The method of Aspect 9, wherein the update is included in a PC5 interface radio resource control (RRC) communication.
Aspect 12: The method of Aspect 9, wherein the update is included in a Uu interface medium access control (MAC) control element (MAC-CE) communication or a PC5 interface MAC-CE communication.
Aspect 13: The method of Aspect 9, wherein the update is included in downlink control information or sidelink control information.
Aspect 14: The method of any of Aspects 1-13, wherein receiving the communication indicating that the first waveform is to be used by the first UE comprises: receiving the communication from a network entity.
Aspect 15: The method of any of Aspects 1-13, wherein receiving the communication indicating that the first waveform is to be used by the first UE comprises: receiving the communication from the second UE or another UE.
Aspect 16: The method of any of Aspects 1-15, wherein the condition associated with the sidelink channel includes at least one of: a block error rate (BLER) based condition, a bit error rate (BER) based condition, a channel quality based condition, a channel quality indicator (CQI) based condition, a modulation and coding scheme (MCS) based condition, a signal-to-interference-plus-noise ratio (SINR) based condition, a reference signal received power (RSRP) based condition, a reference signal received quality (RSRQ) based condition, or a pathloss based condition.
Aspect 17: The method of any of Aspects 1-16, further comprising: measuring a parameter associated with the sidelink channel, wherein the first waveform is based at least in part on the measurement of the parameter and the condition.
Aspect 18: The method of any of Aspects 1-17, further comprising: receiving, from the second UE, an indication of a measurement of a parameter associated with the sidelink channel, wherein the first waveform is based at least in part on the measurement of the parameter and the condition.
Aspect 19: The method of any of Aspects 1-18, wherein the condition includes a cast type associated with the first sidelink signal, and wherein the first waveform is used based at least in part on the first waveform being associated with the cast type.
Aspect 20: The method of Aspect 19, wherein the cast type includes at least one of: unicast, groupcast, or multicast.
Aspect 21: The method of any of Aspects 1-20, wherein a first one or more waveforms, from the multiple waveforms, are associated with a first cast type, and wherein a second one or more waveforms, from the multiple waveforms, are associated with a second cast type.
Aspect 22: The method of any of Aspects 1-21, further comprising: receiving an indication of respective cast types associated with waveforms of the multiple waveforms, and wherein communicating the first sidelink signal using the first waveform is based at least in part on the first sidelink signal being associated with a cast type associated with the first waveform.
Aspect 23: The method of Aspect 22, wherein the respective cast types are associated with all sidelink resource pools including the sidelink resource pool.
Aspect 24: The method of Aspect 22, wherein the respective cast types are specific to the sidelink resource pool.
Aspect 25: The method of any of Aspects 1-24, wherein receiving the communication indicating that the first waveform is to be used by the first UE comprises: receiving, from the second UE, a sidelink radio resource control (RRC) communication indicating that the first waveform is to be used by the first UE as part of an RRC connection establishment procedure with the second UE.
Aspect 26: The method of any of Aspects 1-25, wherein the first sidelink signal is associated with a sidelink configured grant, the method further comprising: receiving a sidelink configured grant configuration, associated with the sidelink configured grant, indicating that the first waveform is to be used for signals associated with the sidelink configured grant configuration.
Aspect 27: The method of Aspect 26, further comprising: transmitting, to the second UE, an indication that the first waveform is to be used for signals associated with the sidelink configured grant configuration.
Aspect 28: The method of any of Aspects 1-27, wherein receiving the communication indicating that the first waveform is to be used by the first UE comprises: receiving, from the second UE and prior to communicating the first sidelink signal, a second sidelink signal using the first waveform; and wherein communicating the first sidelink signal comprises: transmitting, to the second UE, the first sidelink signal using the first waveform based at least in part on receiving the second sidelink signal using the first waveform.
Aspect 29: The method of any of Aspects 1-28, wherein communicating the first sidelink signal comprises: communicating the first sidelink signal and any retransmissions of the first sidelink signal using the first waveform.
Aspect 30: The method of any of Aspects 1-29, further comprising: communicating, with the second UE or another UE, a second sidelink signal using a second waveform from the multiple waveforms.
Aspect 31: The method of any of Aspects 1-30, wherein the multiple waveforms include at least one of: a cyclic prefix orthogonal frequency-division multiplexing (CP-OFDM) based waveform, a single carrier (SC) based waveform, a discrete Fourier transform spread orthogonal frequency-division multiplexing (DFT-s-OFDM) based waveform, or an SC quadrature amplitude modulation (SC-QAM) based waveform.
Aspect 32: A method of wireless communication performed by a wireless communication device, comprising: transmitting, to a first user equipment (UE), a sidelink resource pool configuration indicating multiple waveforms that are available for use for sidelink signals associated with a sidelink resource pool; and transmitting, to the first UE, an indication of a first waveform, from the multiple waveforms, that is to be used by the first UE for sidelink communications associated with the sidelink resource pool.
Aspect 33: The method of Aspect 32, further comprising: transmitting an indication of one or more default waveforms to be used by the first UE.
Aspect 34: The method of Aspect 33, wherein the one or more default waveforms include a first default waveform associated with a first frequency band and a second default waveform associated with a second frequency band.
Aspect 35: The method of any of Aspects 32-34, further comprising: transmitting, to the first UE, an indication of an update to the sidelink resource pool configuration, wherein the update indications a modification to the multiple waveforms.
Aspect 36: The method of Aspect 35, wherein the wireless communication device includes a network entity, and wherein the update is included in a Uu interface radio resource control (RRC) communication.
Aspect 37: The method of Aspect 35, wherein the wireless communication device includes a second UE, and wherein the update is included in a PC5 interface radio resource control (RRC) communication.
Aspect 38: The method of Aspect 35, wherein the update is included in a Uu interface medium access control (MAC) control element (MAC-CE) communication or a PC5 interface MAC-CE communication.
Aspect 39: The method of Aspect 35, wherein the update is included in downlink control information or sidelink control information.
Aspect 40: The method of any of Aspects 32-39, wherein the sidelink resource pool configuration indicates one or more conditions associated with a use of the multiple waveforms by the first UE.
Aspect 41: The method of Aspect 40, wherein the one or more conditions include at least one of: a block error rate (BLER) based condition, a bit error rate (BER) based condition, a channel quality based condition, a channel quality indicator (CQI) based condition, a modulation and coding scheme (MCS) based condition, a signal-to-interference-plus-noise ratio (SINR) based condition, a reference signal received power (RSRP) based condition, a reference signal received quality (RSRQ) based condition, or a pathloss based condition.
Aspect 42: The method of any of Aspects 40-41, wherein the one or more conditions include a cast type associated with a sidelink communication.
Aspect 43: The method of Aspect 42, wherein the cast type includes at least one of: unicast, groupcast, or multicast.
Aspect 44: The method of any of Aspects 32-43, wherein a first one or more waveforms, from the multiple waveforms, are associated with a first cast type, and wherein a second one or more waveforms, from the multiple waveforms, are associated with a second cast type.
Aspect 45: The method of any of Aspects 32-44, further comprising: transmitting, to the first UE, an indication of respective cast types associated with waveforms of the multiple waveforms.
Aspect 46: The method of Aspect 45, wherein the respective cast types are associated with all sidelink resource pools including the sidelink resource pool.
Aspect 47: The method of Aspect 45, wherein the respective cast types are specific to the sidelink resource pool.
Aspect 48: The method of any of Aspects 32-47, wherein the wireless communication device is a second UE, and wherein transmitting the indication that the first waveform is to be used by the first UE comprises: transmitting, to the first UE, a sidelink radio resource control (RRC) communication indicating that the first waveform is to be used by the first UE as part of an RRC connection establishment procedure with the first UE.
Aspect 49: The method of any of Aspects 32-48, further comprising: transmitting, to the first UE, a sidelink configured grant configuration, associated with a sidelink configured grant, indicating that the first waveform is to be used for signals associated with the sidelink configured grant configuration.
Aspect 50: The method of any of Aspects 32-49, wherein the first waveform is to be used for an initial sidelink transmission and any retransmissions of the initial sidelink transmission.
Aspect 51: The method of any of Aspects 32-50, wherein the multiple waveforms include at least one of: a cyclic prefix orthogonal frequency-division multiplexing (CP-OFDM) based waveform, a single carrier (SC) based waveform, a discrete Fourier transform spread orthogonal frequency-division multiplexing (DFT-s-OFDM) based waveform, or an SC quadrature amplitude modulation (SC-QAM) based waveform.
Aspect 52: The method of any of Aspects 32-51, wherein the wireless communication device is a network entity.
Aspect 53: The method of any of Aspects 32-51, wherein the wireless communication device is a second UE.
Aspect 54: An apparatus for wireless communication at a device, comprising a processor; memory coupled with the processor; and instructions stored in the memory and executable by the processor to cause the apparatus to perform the method of one or more of Aspects 1-31.
Aspect 55: A device for wireless communication, comprising a memory and one or more processors coupled to the memory, the one or more processors configured to perform the method of one or more of Aspects 1-31.
Aspect 56: An apparatus for wireless communication, comprising at least one means for performing the method of one or more of Aspects 1-31.
Aspect 57: A non-transitory computer-readable medium storing code for wireless communication, the code comprising instructions executable by a processor to perform the method of one or more of Aspects 1-31.
Aspect 58: A non-transitory computer-readable medium storing a set of instructions for wireless communication, the set of instructions comprising one or more instructions that, when executed by one or more processors of a device, cause the device to perform the method of one or more of Aspects 1-31.
Aspect 59: An apparatus for wireless communication at a device, comprising a processor; memory coupled with the processor; and instructions stored in the memory and executable by the processor to cause the apparatus to perform the method of one or more of Aspects 32-53.
Aspect 60: A device for wireless communication, comprising a memory and one or more processors coupled to the memory, the one or more processors configured to perform the method of one or more of Aspects 32-53.
Aspect 61: An apparatus for wireless communication, comprising at least one means for performing the method of one or more of Aspects 32-53.
Aspect 62: A non-transitory computer-readable medium storing code for wireless communication, the code comprising instructions executable by a processor to perform the method of one or more of Aspects 32-53.
Aspect 63: A non-transitory computer-readable medium storing a set of instructions for wireless communication, the set of instructions comprising one or more instructions that, when executed by one or more processors of a device, cause the device to perform the method of one or more of Aspects 32-53.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
obtain a sidelink resource pool configuration indicating multiple waveforms that are available for use for sidelink signals associated with a sidelink resource pool; and
communicate, with a second UE and via a sidelink channel, a first sidelink signal associated with the sidelink resource pool, wherein the first sidelink signal uses a first waveform from the multiple waveforms, and wherein the first waveform is used based at least in part on at least one of:
a condition associated with the sidelink channel, or
receiving a communication indicating that the first waveform is to be used by the first UE.

2. The first UE of claim 1, wherein the one or more processors are further configured to:
communicate, with the second UE or another UE and prior to obtaining the sidelink resource pool configuration, a second sidelink signal using a default waveform.

3. The first UE of claim 2, wherein the default waveform is based at least in part on a frequency band used to communicate the second sidelink signal.

4. The first UE of claim 2, wherein the one or more processors are further configured to:
receive an indication of one or more default waveforms, including the default waveform, to be used by the first UE.

5. The first UE of claim 1, wherein the one or more processors are further configured to:
receive, from the second UE, an indication of a measurement of a parameter associated with the sidelink channel,
wherein the first waveform is based at least in part on the measurement of the parameter and the condition.

6. The first UE of claim 1, wherein a first one or more waveforms, from the multiple waveforms, are associated with a first cast type, and
wherein a second one or more waveforms, from the multiple waveforms, are associated with a second cast type.

7. The first UE of claim 1, wherein the one or more processors are further configured to:
receive an indication of respective cast types associated with waveforms of the multiple waveforms, and wherein communicating the first sidelink signal using the first waveform is based at least in part on the first sidelink signal being associated with a cast type associated with the first waveform, and wherein the respective cast types are specific to the sidelink resource pool.

8. The first UE of claim 1, wherein the first sidelink signal is associated with a sidelink configured grant, and wherein the one or more processors are further configured to:
receive a sidelink configured grant configuration, associated with the sidelink configured grant, indicating that the first waveform is to be used for signals associated with the sidelink configured grant configuration; and
transmit, to the second UE, an indication that the first waveform is to be used for signals associated with the sidelink configured grant configuration.

9. The first UE of claim 1, wherein the one or more processors, to receive the communication indicating that the first waveform is to be used by the first UE, are configured to:
receive, from the second UE and prior to communicating the first sidelink signal, a second sidelink signal using the first waveform; and
wherein the one or more processors, to communicate the first sidelink signal, are configured to:
transmit, to the second UE, the first sidelink signal using the first waveform based at least in part on receiving the second sidelink signal using the first waveform.

10. The first UE of claim 1, wherein the one or more processors, to communicate the first sidelink signal, are configured to:
communicate the first sidelink signal and any retransmissions of the first sidelink signal using the first waveform.

11. A wireless communication device for wireless communication, comprising:
a memory; and
one or more processors, coupled to the memory, configured to:
transmit, to a first user equipment (UE), a sidelink resource pool configuration indicating multiple waveforms that are available for use for sidelink signals associated with a sidelink resource pool; and
transmit, to the first UE, an indication of a first waveform, from the multiple waveforms, that is to be used by the first UE for sidelink communications associated with the sidelink resource pool.

12. The wireless communication device of claim 11, wherein the one or more processors are further configured to:
transmit an indication of one or more default waveforms to be used by the first UE, wherein the one or more default waveforms include a first default waveform associated with a first frequency band and a second default waveform associated with a second frequency band.

13. The wireless communication device of claim 11, wherein the one or more processors are further configured to:
transmit, to the first UE, an indication of an update to the sidelink resource pool configuration, wherein the update indications a modification to the multiple waveforms.

14. The wireless communication device of claim 11, wherein the sidelink resource pool configuration indicates one or more conditions associated with a use of the multiple waveforms by the first UE, wherein the one or more conditions include at least one of:
a block error rate (BLER) based condition,
a bit error rate (BER) based condition,
a channel quality based condition,
a channel quality indicator (CQI) based condition,
a modulation and coding scheme (MCS) based condition,
a signal-to-interference-plus-noise ratio (SINR) based condition,
a reference signal received power (RSRP) based condition,
a reference signal received quality (RSRQ) based condition, or
a pathloss based condition.

15. The wireless communication device of claim 11, wherein the wireless communication device is a second UE, and wherein transmitting the indication that the first waveform is to be used by the first UE comprises:
transmit, to the first UE, a sidelink radio resource control (RRC) communication indicating that the first waveform is to be used by the first UE as part of an RRC connection establishment procedure with the first UE.

16. A method of wireless communication performed by a first user equipment (UE), comprising:
obtaining a sidelink resource pool configuration indicating multiple waveforms that are available for use for sidelink signals associated with a sidelink resource pool; and
communicating, with a second UE and via a sidelink channel, a first sidelink signal associated with the sidelink resource pool, wherein the first sidelink signal uses a first waveform from the multiple waveforms, and wherein the first waveform is used based at least in part on at least one of:
a condition associated with the sidelink channel, or
receiving a communication indicating that the first waveform is to be used by the first UE.

17. The method of claim 16, wherein obtaining the sidelink resource pool configuration comprises:
receiving the sidelink resource pool configuration from a network entity, the second UE or another UE.

18. The method of claim 16, further comprising: receiving an indication of an update to the sidelink resource pool configuration, wherein the update indicates a modification to the first waveform, and wherein communicating the first sidelink signal includes communicating in accordance with the modification to the first waveform.

19. The method of claim 18, wherein the update is included in a Uu interface radio resource control (RRC) communication, a PC5 interface RRC communication, a Uu interface medium access control (MAC) control element (MAC-CE) communication, a PC5 interface MAC-CE communication, downlink control information, or sidelink control information.

20. The method of claim 16, wherein the condition associated with the sidelink channel includes at least one of:
a block error rate (BLER) based condition,
a bit error rate (BER) based condition,
a channel quality based condition,
a channel quality indicator (CQI) based condition,
a modulation and coding scheme (MCS) based condition,
a signal-to-interference-plus-noise ratio (SINR) based condition,
a reference signal received power (RSRP) based condition,
a reference signal received quality (RSRQ) based condition, or
a pathloss based condition.

21. The method of claim 16, further comprising:
measuring a parameter associated with the sidelink channel,
wherein the first waveform is based at least in part on the measurement of the parameter and the condition.

22. The method of claim 16, further comprising:
receiving an indication of respective cast types associated with waveforms of the multiple waveforms, and wherein communicating the first sidelink signal using the first waveform is based at least in part on the first sidelink signal being associated with a cast type associated with the first waveform, and wherein the respective cast types are associated with all sidelink resource pools including the sidelink resource pool.

23. The method of claim 16, wherein receiving the communication indicating that the first waveform is to be used by the first UE comprises:
receiving, from the second UE, a sidelink radio resource control (RRC) communication indicating that the first waveform is to be used by the first UE as part of an RRC connection establishment procedure with the second UE.

24. The method of claim 16, wherein the first sidelink signal is associated with a sidelink configured grant, the method further comprising:
receiving a sidelink configured grant configuration, associated with the sidelink configured grant, indicating that the first waveform is to be used for signals associated with the sidelink configured grant configuration.

25. The method of claim 16, wherein receiving the communication indicating that the first waveform is to be used by the first UE comprises:
receiving, from the second UE and prior to communicating the first sidelink signal, a second sidelink signal using the first waveform; and
wherein communicating the first sidelink signal comprises:
transmitting, to the second UE, the first sidelink signal using the first waveform based at least in part on receiving the second sidelink signal using the first waveform.

26. A method of wireless communication performed by a wireless communication device, comprising:
transmitting, to a first user equipment (UE), a sidelink resource pool configuration indicating multiple waveforms that are available for use for sidelink signals associated with a sidelink resource pool; and
transmitting, to the first UE, an indication of a first waveform, from the multiple waveforms, that is to be used by the first UE for sidelink communications associated with the sidelink resource pool.

27. The method of claim 26, further comprising:
transmitting an indication of one or more default waveforms to be used by the first UE.

28. The method of claim 26, wherein the sidelink resource pool configuration indicates one or more conditions associated with a use of the multiple waveforms by the first UE.

29. The method of claim 26, wherein the wireless communication device is a second UE, and wherein transmitting the indication that the first waveform is to be used by the first UE comprises:
transmitting, to the first UE, a sidelink radio resource control (RRC) communication indicating that the first waveform is to be used by the first UE as part of an RRC connection establishment procedure with the first UE.

30. The method of claim 26, further comprising:
transmitting, to the first UE, a sidelink configured grant configuration, associated with a sidelink configured grant, indicating that the first waveform is to be used for signals associated with the sidelink configured grant configuration.
